(19) United States
(12) Patent Application Publication
(10) Pub. No.: US 2026/0173039 A1
(43) Pub. Date: Jun. 18, 2026

(54) TIMING CONTROL FOR MULTI-PANEL WTRU TRANSMISSION

(71) Applicant: InterDigital Patent Holdings, Inc., Wilmington, DE (US)

(72) Inventors: Jonghyun Park, Syosset, NY (US); Afshin Haghighat, Ile-Bizard (CA); Dylan Watts, Montreal (CA); Moon-il Lee, Melville, NY (US); Loic Canonne-Velasquez, Dorval (CA); Virgil Comsa, Montreal (CA)

(73) Assignee: InterDigital Patent Holdings, Inc., Wilmington, DE (US)

(21) Appl. No.: 19/124,312

(22) PCT Filed: Nov. 1, 2023
(86) PCT No.: PCT/US2023/036611

§ 371 Date: Apr. 25, 2025

Related U.S. Application Data
(60) Provisional application No. 63/421,867, filed on Nov. 2, 2022.
(60) Provisional application No. 63/540,707, filed on Sep. 27, 2023.

(51) Int. Cl. H04W 72/0446; H04L 5/00

(52) U.S. Cl. CPC H04W 72/0446; H04L 5/001

(57) ABSTRACT

A wireless transmit/receive unit (WTRU) may determine, based on received configuration information, that a cell is associated with a first transmit and receive point (TRP) and a second TRP. The first TRP may be associated with a first timing advance group (TAG). The second TRP may be associated with a second TAG. The first TAG may be a primary TAG. The WTRU may determine that a first time alignment timer (TAT) associated with the first TAG has expired. The WTRU may, based on the determination that the first TAT has expired, determine that a timing advance (TA) associated with the second TAG is to be used for a transmission to the cell. The WTRU may send, in accordance with the TA associated with the second TAG, the transmission to the cell.

### CROSS-REFERENCE TO RELATED APPLICATIONS

This application claims the benefit of Provisional U.S. Patent Application No. 63/421,867, filed Nov. 2, 2022, and Provisional U.S. Patent Application No. 63/540,707, filed Sep. 27, 2023, the disclosure of which is incorporated herein by reference in their entireties.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for sending a transmission to a cell associated with multiple transmit and receive points (TRPs). In examples, a wireless transmit/receive unit (WTRU) may determine, based on received configuration information, that a cell is associated with a first transmit and receive point (TRP) and a second TRP. The first TRP may be associated with a first timing advance group (TAG). The second TRP may be associated with a second TAG. The first TAG may be a primary TAG. The WTRU may determine that a first time duration (e.g., a first time alignment timer (TAT)) associated with the first TAG has expired. Based on the determination that the first time duration has expired, the WTRU may determine that a timing advance (TA) associated with the second TAG is to be used for a transmission to the cell. The WTRU may send, based on the TA associated with the second TAG, the transmission to the cell.

In examples, the cell may be associated with two primary TAGS: the first TAG may be a first primary TAG associated with the cell; and the second TAG associated with the second TRP may be a second primary TAG associated with the cell. The first primary TAG may be associated with a first time duration, and the second primary TAG may be associated with a second time duration (e.g., a second TAT). The WTRU may determine data and/or control information that is to be sent to the cell. The WTRU may determine that the first time duration associated with the first primary TAG has expired and that the second time duration associated with the second primary TAG has not expired and based on this determination, send, based on the TA associated with the second TAG, the data and/or control information to the cell. The WTRU may, based on the determination that the first time duration associated with the first primary TAG has expired and that the second time duration associated with the second primary TAG has not expired, refrain from sending, based on a TA associated with the first TAG, the data and/or control information. In some examples, the WTRU may determine that data and/or control information transmitted via the first TRP is to be retransmitted (e.g., after the WTRU determines that the transmission of the data and/or control information via the first TRP has failed). The WTRU may, based on the determination that the first time duration associated with the first primary TAG has expired, transmit the data and/or control information via the second TRP, and when the data and/or control information is transmitted via the second TRP, a hybrid automatic repeat request (HARQ) buffer associated with the first TRP may still include the data and/or control information or a copy of the data and/or control information.

In some examples, the WTRU, based on the determination that the first time duration associated with the first primary TAG has expired, perform one or more of: maintaining the HARQ buffer associated with the first TRP; a release of a resource associated with a physical uplink control channel (PUCCH) transmission that is scheduled to be sent to the cell or the first TRP; a release of a resource associated with a sounding reference signal (SRS) that is to be sent to the cell or the first TRP; a release of a resource that is scheduled via a configured downlink assignment for a downlink transmission associated with the cell or the first TRP; a release of a resource that is scheduled via a configured uplink grant for an uplink transmission associated with the cell or the first TRP; or a release of a resource that is scheduled for a physical uplink shared channel (PUSCH) transmission for semi-persistent channel state information (CSI) reporting associated with the cell or the first TRP.

In examples, the cell may be associated with a primary TAG, which may be the first TAG. The WTRU may determine that a time (e.g., an offset time before an expiration of the TAT associated with the primary TAG) has been reached. The WTRU may send a request, based on the determination that the time has been reached, to change the primary TAG from the first TAG associated with the first TRP to the second TAG associated with the second TRP. The request may be sent before the expiration of the first time duration associated with the first TAG. For example, the WTRU may send, using the TA associated with the second TAG, a first transmission including the request. The first transmission may include an indication that the offset time before the expiration of the first time duration has been reached. In some examples, the WTRU may determine that the first time duration is to expire at a first time. The WTRU may determine that the difference between a current time and the first time is less than or equal to a value. The WTRU may send a request, based on the determination that the difference between the current time and the first time is less than or equal to a value, to change the primary TAG from the first TAG associated with the first TRP to the second TAG associated with the second TRP, and the request may be sent before the expiration of the first time duration.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of multi-TRP (MTRP) operation and switching with multiple timing advance group (TAG) associations.

FIG. 3 illustrates an example of a PTAG switching or maintaining a PTAG on a different TRP.

FIG. 4 illustrates an example 400 of TAG switching for a transmission.

### DETAILED DESCRIPTION

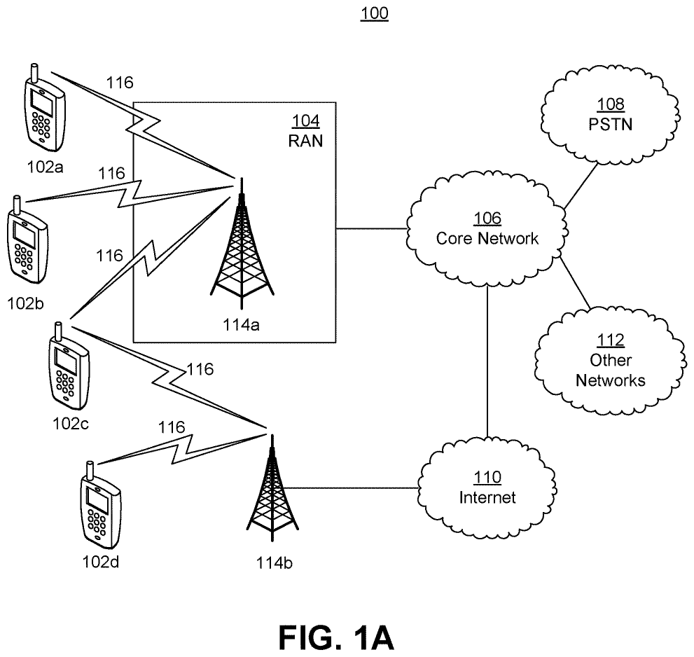

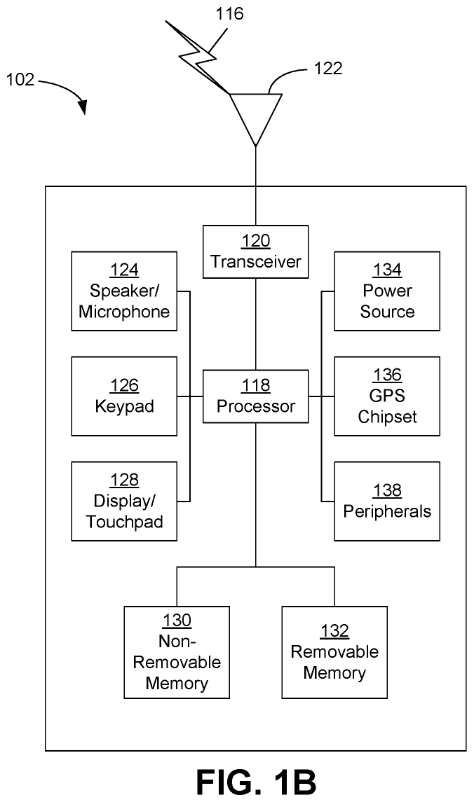

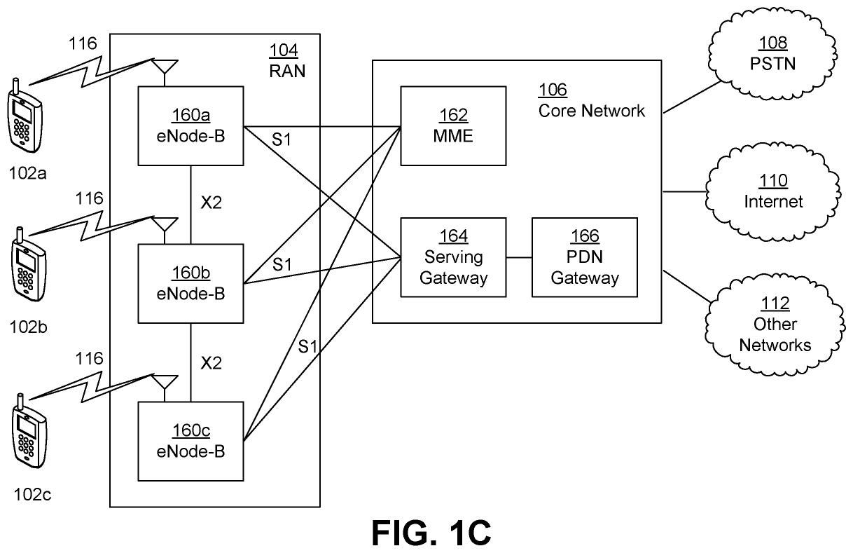

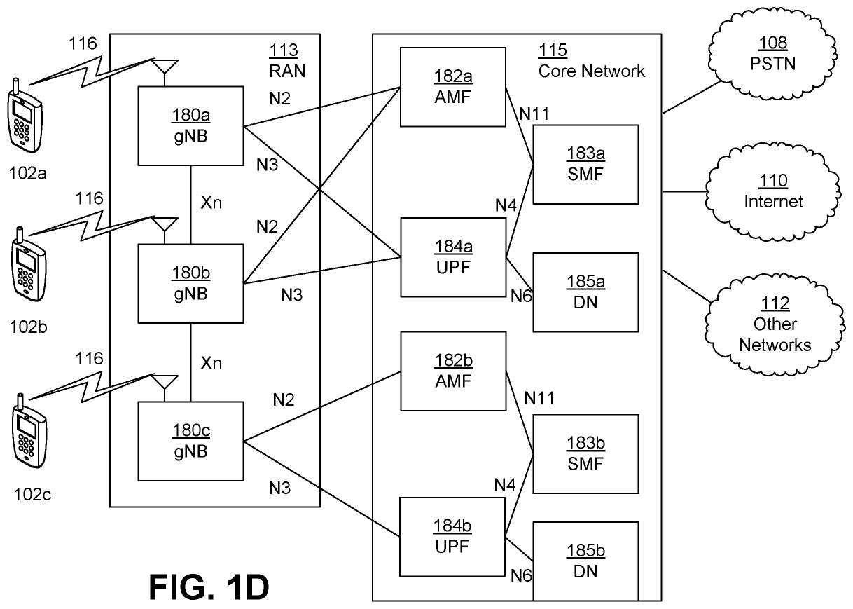

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHx, 80 MHz, and/or 160 MHz wide channels. The 40 MHx, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHx, 2 MHx, 4 MHx, 8 MHx, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHx, 4 MHz, 8 MHx, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for timing control for multi-panel WTRU transmission. A WTRU may determine a transmission/reception point identity (TRP-id), for example, based on physical downlink control channel (PDCCH) related information for monitoring the downlink control information (DCI) format for the PDCCH order, e.g., based on a control resource set (CORESET) pool identity (CORESETPoolID), a CORESET-id, a PDCCH search space-id, and/or PDCCH candidate resources.

The WTRU may determine one or more parameters for a physical downlink control channel (PDCCH) ordered physical random access channel (PRACH) transmission, for example, based on the transmission/reception point identity (TRP-id). One or more parameters may include, for example, at least one of the following: a random access preamble index (ra-PreambleIndex); an uplink (UL)/supplemental uplink (SUL) indicator; a synchronization signal (SS)/physical broadcasting channel (PBCH) index, which may determine random access channel (RACH) occasions; a PRACH Mask index, which may determine a subset of RACH occasions determined from an SS/PBCH index, and so on.

The WTRU may send a physical downlink control channel (PDCCH) ordered physical random access channel (PRACH) transmission based on at least one determined parameters. The WTRU may receive a random access response (RAR) in response to the physical downlink control channel (PDCCH) ordered physical random access channel (PRACH) transmission. The RAR associated with the PDCCH ordered PRACH transmission may include one or more of the following: associated PRACH preamble related information, associated TRP-id, associated TAG, or associated SRS resource set information.

A WTRU may promote a timing advance group (TAG) (e.g., (P) STAG configured in a special cell (SpCell)) to the primary TAG (PTAG), for example, based on one or more of the following conditions: whether the primary cell (PCell) includes multiple TRPs; a network (NW) configuration (e.g., an RRC configuration to enable/disable promotion to PTAG); an NW indication (e.g., via reception of an (explicit) indication in system information, a medium access control (MAC) control element (CE), and/or downlink control information (DCI)); whether a time alignment timer (TAT) associated with the PTAG has expired or is about to expire; whether a TAT associated with the PSTAG is still running; whether the TAT associated with the PSTAG has a configured amount of time remaining; and/or whether the reference signal received power (RSRP) on one or more TRP links is above a threshold.

A WTRU may switch from a first TAG to a second TAG. For example, the WTRU may determine that a first TAT associated with the first TAG is near expiry. The WTRU may transmit (e.g., to a second TRP associated with the second TAG or to a second cell associated with the second TAG), a message indicating the first TAT is near expiry (e.g., a remaining time until/before the expiry of the first TAT may be less than a threshold, where the threshold may be configured or indicated from a gNB to the WTRU).

In examples, a WTRU may receive configuration information that indicates a cell associated with a first transmit and receive point (TRP) and a second TRP. The first TRP may be associated with a first timing advance group (TAG) and a first time alignment timer (TAT), and the second TRP may be associated with a second TAG and a second TAT. The first TAG may be a primary TAG. The WTRU may determine that an offset time from expiration of the first TAT has been reached. The WTRU may send, based on the determination that the offset time from the expiration of the first TAT has been reached, a first transmission using a first timing advance (TA) associated with the second TAG. The first transmission may include a request to switch the second TAG to be the primary TAG. The WTRU may receive approval of the request. The WTRU may send a second transmission using a second TA associated with the second TAG (e.g., the second transmission may be sent after the expiration of the first TAT). The second transmission may be sent to the second TRP or a second cell associated with the second TAG. The first transmission may be sent, before the expiration of the first TAT, to the second TRP or the second cell. The first transmission may include an indication that the offset time from the expiration of the first TAT has been reached. The WTRU may be allowed to transmit to the cell (and a second cell) when a TAT associated with the primary TAG has not expired.

The PTAG switching behavior may be applicable based on different scenarios (e.g., a 1-PTAG model or a 2-PTAG model). A 2-PTAG model may include more than one PTAGs (e.g., both TAGs of a cell may be PTAGs), where the WTRU may transmit information indicating that the second TAG is to be used in determining whether to perform recovery (e.g., one or more recovery actions herein) across cells.

An example PTAG switching in a multi-TRP and CA scenario may be provided. For example, a WTRU may receive configuration information indicating a first cell is associated with a first and second TRP, where the first TRP is associated with the first TAG (e.g., a PTAG) and a first TAT, and the second TRP may be associated with the second TAG and the second TAT. The WTRU may determine that the first TAT is nearing expiry (e.g., offset from expiry). The WTRU may transmit to the second TRP or to a second cell associated with the second TAG, a message indicating the first TAT is nearing expiry and a request to switch PTAG from the first TAG to the second TAG. The WTRU may receive confirmation for the switch request. The WTRU may transmit UL signals to the first cell or the second cell (e.g., using a TA associated with the second TAG) after the expiry of the first TAT.

An example TAG association between TRP/cell and WTRU-panel may be provided. For example, a WTRU may receive configuration information indicating a first and second SRS resource set for simultaneous Tx from multiple WTRU-panels (STxMP). The WTRU may receive a scheduling grant (e.g., for STxMP of a UL channel or signal), indicating a first and second set of layers of the UL are associated with a respective first and second TAG/PCI (e.g., physical cell-ID, e.g., inter-cell MTRP). The WTRU may determine the first and second set of layers are respectively mapped to the first and second SRS resource set (WTRU-panel), based on more than one SRS resource indicator (SRI) associated with the scheduling grant. The WTRU may transmit the first set of layers from a first WTRU-panel using a first TA based on the first TAG (and the first PCI) and (e.g., simultaneously) the second set of layers from a second WTRU-panel using a second TA based on the second TAG (and the second PCI).

Systems, methods, and instrumentalities are described herein for sending a transmission to a cell associated with multiple transmit and receive points (TRPs). In examples, a wireless transmit/receive unit (WTRU) may determine, based on received configuration information, that a cell is associated with a first transmit and receive point (TRP) and a second TRP. The first TRP may be associated with a first timing advance group (TAG). The second TRP may be associated with a second TAG. The first TAG may be a primary TAG. The WTRU may determine that a first time duration (e.g., a first time alignment timer (TAT)) associated with the first TAG has expired. Based on the determination that the first time duration has expired, the WTRU may determine that a timing advance (TA) associated with the second TAG is to be used for a transmission to the cell. The WTRU may send, based on the TA associated with the second TAG, the transmission to the cell.

In examples, the cell may be associated with two primary TAGs: the first TAG may be a first primary TAG associated with the cell; and the second TAG associated with the second TRP may be a second primary TAG associated with the cell. The first primary TAG may be associated with a first time duration, and the second primary TAG may be associated with a second time duration (e.g., a second TAT). The WTRU may determine data and/or control information that is to be sent to the cell. The WTRU may determine that the first time duration associated with the first primary TAG has expired and that the second time duration associated with the second primary TAG has not expired and based on this determination, send, based on the TA associated with the second TAG, the data and/or control information to the cell. The WTRU may, based on the determination that the first time duration associated with the first primary TAG has expired and that the second time duration associated with the second primary TAG has not expired, refrain from sending, based on a TA associated with the first TAG, the data and/or control information. In some examples, the WTRU may determine that data and/or control information transmitted via the first TRP is to be retransmitted (e.g., after the WTRU determines that the transmission of the data and/or control information via the first TRP has failed). The WTRU may, based on the determination that the first time duration associated with the first primary TAG has expired, transmit the data and/or control information via the second TRP, and when the data and/or control information is transmitted via the second TRP, a hybrid automatic repeat request (HARQ) buffer associated with the first TRP may still include the data and/or control information or a copy of the data and/or control information.

In some examples, the WTRU, based on the determination that the first time duration associated with the first primary TAG has expired, perform one or more of: maintaining the HARQ buffer associated with the first TRP; a release of a resource associated with a physical uplink control channel (PUCCH) transmission that is scheduled to be sent to the cell or the first TRP; a release of a resource associated with a sounding reference signal (SRS) that is to be sent to the cell or the first TRP; a release of a resource that is scheduled via a configured downlink assignment for a downlink transmission associated with the cell or the first TRP; a release of a resource that is scheduled via a configured uplink grant for an uplink transmission associated with the cell or the first TRP; or a release of a resource that is scheduled for a physical uplink shared channel (PUSCH) transmission for semi-persistent channel state information (CSI) reporting associated with the cell or the first TRP.

In examples, the cell may be associated with a primary TAG, which may be the first TAG. The WTRU may determine that a time (e.g., an offset time before an expiration of the TAT associated with the primary TAG) has been reached. The WTRU may send a request, based on the determination that the time has been reached, to change the primary TAG from the first TAG associated with the first TRP to the second TAG associated with the second TRP. The request may be sent before the expiration of the first time duration associated with the first TAG. For example, the WTRU may send, using the TA associated with the second TAG, a first transmission including the request. The first transmission may include an indication that the offset time before the expiration of the first time duration has been reached. In some examples, the WTRU may determine that the first time duration is to expire at a first time. The WTRU may determine that the difference between a current time and the first time is less than or equal to a value. The WTRU may send a request, based on the determination that the difference between the current time and the first time is less than or equal to a value, to change the primary TAG from the first TAG associated with the first TRP to the second TAG associated with the second TRP, and the request may be sent before the expiration of the first time duration.

A unified transmission configuration indicator (TCI) framework may support a (e.g., one) unified TCI (e.g., joint or a pair of separate DL/UL). A unified TCI may be indicated/maintained at a WTRU, for example, to be (e.g., simultaneously) applicable for control/data channels, which may be different from an individual beam control per channel.

Multi-TRP (MTRP) may support multi-DCI based MTRP (MDCI-MTRP), for example, based on CORESETPoolIndex=0 or 1, to support eMBB, and/or single-DCI based MTRP (SDCI-MTRP), for example, based on associating multiple (e.g., up to two) TCI-states for a codepoint of a TCI field in a DCI, for repeated transmissions across TRPs, and/or for reliability enhancements. Multi-TRP may be used interchangeably with MTRP, mTRP, M-TRP, and multiple transmission and reception points.

Multiple input multiple output (MIMO) may be supported. Simultaneous multi-panel UL transmission may be facilitated, e.g., for higher UL throughput/reliability. Frequency range two (FR2) and/or multi-TRP may be supported, for example, with one or more (e.g., up to two (2)) TRPs and/or one or more (e.g., up to two (2)) panels, e.g., for customer premises equipment (CPE)/fixed wireless access (FWA)/vehicle/industrial devices (if applicable). A UL precoding indication may be provided for PUSCH, e.g., without a new codebook being introduced for multi-panel simultaneous transmission. A total number of layers may be, for example, up to four across all panels. There may be one or more codewords (e.g., a total number of up to two) across one or more (e.g., all) panels, for example, considering single DCI and multi-DCI based multi-TRP operation.

There may be one or more (e.g., two) timing advances (TAs) for UL multi-DCI for multi-TRP operation. Power control may be provided for UL single DCI for multi-TRP operation, e.g., with a unified TCI framework extension.

Latency and/or flexibility may be improved for or based on association among WTRU multi-panels, TRPs, multiple TAGs, an inter-cell MTRP scenario, etc. UL performance may be improved for simultaneous transmission from multiple panels (STxMP), for example, if/when a TA process (e.g., a link between a WTRU panel and a TRP) is determined as failed, e.g., if/when a respective time duration/period (e.g., a timer) expires.

Herein, terms such as “a,” “an” and similar terms/phrases are interpreted as and used interchangeably with “one or more” and “at least one.” Terms that end with the suffix “(s)” are interpreted as “one or more” and “at least one.” The term “may” is interpreted as and used interchangeably with “may, for example.” A sign, symbol, or mark of a forward slash “/” is interpreted as “and/or,” for example, unless expressly indicated otherwise. For example, “A/B” may be interpreted as “A and/or B.”

A WTRU may transmit and/or receive a physical channel transmission or a reference signal according to at least one spatial domain filter. The spatial domain filter may be referred as a beam.

A WTRU may transmit a physical channel and/or signal using the same spatial domain filter as the spatial domain filter used for receiving a reference signal (RS), such as a channel state information (CSI) RS (CSI-RS) or a synchronization signal (SS) block. A WTRU transmission may be referred to as a target. A received RS or a SS block may be referred to as a reference or a source. A WTRU (e.g., in such a case) may be said to transmit a target physical channel or signal according to a spatial relation with a reference to an RS or SS block.

A WTRU may transmit a first physical channel or signal according to the same spatial domain filter as the spatial domain filter used for transmitting a second physical channel or signal. The first and second transmissions may be referred to as “target” and “reference” (or “source”), respectively. A WTRU (e.g., in such a case) may be said to transmit the first (target) physical channel or signal according to a spatial relation with a reference to the second (reference) physical channel or signal.

A spatial relation may be implicit, configured by RRC, and/or signaled by MAC CE or DCI. For example, a WTRU may (e.g., implicitly) transmit a PUSCH and a DM-RS of PUSCH according to the same spatial domain filter as a sounding reference signal (SRS) indicated by an SRS resource indicator (SRI) (e.g., indicated in DCI or configured by RRC). In some examples, a spatial relation may be configured by RRC for an SRI or signaled by MAC CE for a PUCCH. The spatial relation may be referred to as a beam indication.

A WTRU may receive a first (target) downlink channel or signal according to the same spatial domain filter or spatial reception parameter as a second (reference) downlink channel or signal. For example, such an association may exist between a physical channel, such as PDCCH or PDSCH, and the physical channel's respective DM-RS. An association may exist, for example, if/when the first and second signals are reference signals and a WTRU is configured with a quasi-colocation (QCL) assumption type D between corresponding antenna ports. An association may be configured as a transmission configuration indicator (TCI) state. A WTRU may be indicated (e.g., receive an indication of) an association between a CSI-RS or SS block and a DM-RS, for example, by an index to a set of TCI states, which may be configured by RRC and/or signaled by a MAC CE. An indication may be referred to as a beam indication.

A unified TCI (e.g., a common TCI, a common beam, a common RS, etc.) may be referred to as a beam/RS that may be used (e.g., simultaneously used) for multiple physical channels/signals. The term TCI may comprise a TCI state that includes at least one source RS to provide a reference (e.g., WTRU assumption) for determining a quasi-colocation (QCL) and/or a spatial filter.

In some examples, a WTRU may receive (e.g., from a gNB) an indication of a first unified TCI to be used/applied for a physical downlink control channel (PDCCH) and/or a physical downlink shared channel (PDSCH) (e.g., and a downlink RS). Source reference signal(s) in a first unified TCI may provide common QCL information, e.g., for WTRU-dedicated (e.g., UE-dedicated) reception on the PDSCH and/or all or a subset of CORESETs in a component carrier (CC). In some examples, a WTRU may receive (e.g., from a gNB) an indication of a second unified TCI that may be used/applied for an uplink control channel (e.g., a PUCCH) and/or an uplink shared channel (e.g., a PUSCH), and, for example, an uplink RS. One or more source reference signals in the second unified TCI may provide a reference for determining common UL TX spatial filter(s), e.g., for dynamic-grant/configured-grant based PUSCH and all or a subset of dedicated PUCCH resources in a CC.

A WTRU may be configured with a first mode for unified TCI (e.g., SeparateDLULTCI mode). An indicated unified TCI (e.g., the first unified TCI or the second unified TCI) may be applicable for downlink (e.g., based on the first unified TCI) and/or uplink (e.g., based on the second unified TCI).

In some examples, a WTRU may receive (e.g., from a gNB) an indication of a second unified TCI that may be used/applied (e.g., commonly) for a PDCCH, a PDSCH, a PUCCH, and/or a PUSCH (e.g., and a DL RS and/or a UL RS).

A WTRU may be configured with a second mode for a unified TCI (e.g., JointTCI mode). An indicated unified TCI (e.g., the third unified TCI) may be applicable for downlink and uplink (e.g., based on the third unified TCI).

A WTRU may determine a TCI state applicable to a transmission and/or reception, for example, by (e.g., first) determining a unified TCI state instance applicable to the transmission and/or reception. The WTRU may determine a TCI state corresponding to the unified TCI state instance. A transmission may include at least a PUCCH, a PUSCH, or an SRS. A reception may include at least a PDCCH, a PDSCH, or a CSI-RS. A unified TCI state instance may be referred to as a TCI state group, a TCI state process, a unified TCI pool, a group of TCI states, a set of time-domain instances/stamps/slots/symbols, and/or a set of frequency-domain instances/radio bearers (RBs)/subbands, etc. A unified TCI state instance may be equivalent to and/or identified with a CORESET pool identity (e.g., CORESETPoolIndex, a TRP indicator, and/or the like).

The term “unified TCI” as used in one or more examples herein may refer to unified TCI-state(s), unified TCI instance, TCI, and/or TCI-state. The term “TRP” as used in one or more examples herein may refer to transmission point (TP), reception point (RP), radio remote head (RRH), distributed antenna (DA), base station (BS), a sector (e.g., of a BS), and/or a cell (e.g., a geographical cell area served by a BS).

TRPs, SRIs, and/or pathloss (PL) reference RSs may be configured. A WTRU may be configured with (e.g., may receive configuration associated with) one or more TRPs. The WTRU may transmit to and/or from the one or more (e.g., configured) TRPs. The WTRU may be configured with one or more TRPs for one or more cells. A cell may be a serving cell and/or a secondary cell.

A WTRU may be configured with at least one RS, e.g., for the purpose of channel measurement. The at least one RS may be denoted as a channel measurement resource (CMR). The at least one RS may comprise a CSI-RS, a synchronization signal block (SSB), or other downlink RS transmitted from the TRP to a WTRU. A CMR may be configured with and/or otherwise associated with a TCI state. A WTRU may be configured with a CMR group, e.g., where CMRs transmitted from the same TRP may be configured. A (e.g., each) group may be identified by a CMR group index (e.g., group 1). A WTRU may be configured with a (e.g., one) CMR group per TRP. A WTRU may receive a linkage between a (e.g., one) CMR group index and another CMR group index, and/or between a (e.g., one) RS index from a (e.g., one) CMR group and another RS index from another group.

A WTRU may be configured with (e.g., receive configuration of) one or more pathloss (PL) reference groups (e.g., sets) and/or one or more SRS groups, SRIs, and/or SRS resource sets.

A PL reference group may correspond to and/or may be associated with a TRP. A PL reference group may include, identify, correspond to, and/or be associated with one or more TCI states, SRIs, reference signal sets (e.g., CSI-RS set, SRI sets), CORESET index, and/or reference signals (e.g., CSI-RS, SSB).

A WTRU may receive a configuration (e.g., any configuration described herein). A configuration may be received, for example, from a gNB or TRP. For example, a WTRU may receive a configuration of one or more TRPs, one or more PL reference groups, and/or one or more SRI sets. A WTRU may (e.g., implicitly) determine an association between an RS set/group and a TRP. For example, a WTRU may be configured with multiple (e.g., two) SRS resource sets. A WTRU may (e.g., determine to) transmit to TRP1 with SRS in a first resource set and to TRP2 with SRS in a second resource set. A configuration may be received, for example, via RRC signaling.

The examples described herein may be applicable to TRP, PL reference group, SRI group, and SRI set. For example, although certain examples may be described in terms of one of: TRP; PL reference group; SRI group; and SRI set, the example may be applicable to other terms listed here. The terms set and group may be used interchangeably in one or more examples herein.

A WTRU may report a subset of channel state information (CSI) components. CSI components may correspond to, for example, one or more of the following: a CSI-RS resource indicator (CRI); an SSB resource indicator (SSBRI); an indication of a panel used for reception at the WTRU (e.g., a panel identity or group identity); measurements, such as L1-RSRP, L1-SINR taken from SSB or CSI-RS (e.g., cri-RSRP, cri-SINR, ssb-Index-RSRP, ssb-Index-SINR); and/or other channel state information, such as a rank indicator (RI), a channel quality indicator (CQI), a precoding matrix indicator (PMI), a layer index (LI), and/or the like.

A grant or assignment may include or be associated with one or more properties. A property of a grant or assignment may include, for example, at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; an indication of whether a repetition scheme is Type A or Type B; an indication of whether a grant is a configured grant type 1, type 2 or a dynamic grant; an indication of whether an assignment is a dynamic assignment or a semi-persistent scheduling (e.g., configured) assignment; a configured grant index or a semi-persistent assignment index; a periodicity of a configured grant or assignment; a channel access priority class (CAPC); a (e.g., any) parameter (e.g., provided in a DCI, by MAC, or by RRC) for the scheduling the grant or assignment.

An indication in a DCI (e.g., an indication received using a DCI) may include, for example, at least one of the following: an (e.g., explicit) indication by a DCI field or by Radio Network Identifier (RNTI) used to mask a cyclic redundancy check (CRC) of the PDCCH; or an (e.g., implicit) indication by a property, such as a DCI format, a DCI size, a CORESET or search space, an aggregation level, a first resource element of the received DCI (e.g., index of a first control channel element), e.g., where the mapping between the property and the value may be signaled by RRC or MAC.

The term “signal” as used in one or more examples herein may refer to one or more of following: a sounding reference signal (SRS); a channel state information-reference signal (CSI-RS); a demodulation reference signal (DM-RS); a phase tracking reference signal (PT-RS); and/or a synchronization signal block (SSB).

The term “channel” as used in one or more examples herein may refer to one or more of following: a physical downlink control channel (PDCCH); a physical downlink shared channel (PDSCH); a physical uplink control channel (PUCCH); a physical uplink shared channel (PUSCH); a physical random access channel (PRACH); etc.

The term “downlink reception” as used in one or more examples herein may refer to one or more of the following: an Rx occasion, PDCCH, PDSCH, and/or SSB reception. The term “uplink transmission” as used in one or more examples herein may refer to one or more of the following: transmission (Tx) occasion, PUCCH, PUSCH, PRACH, and/or SRS transmission.

The term “reference signal (RS)” as used in one or more examples herein may refer to one or more of the following: RS resource, RS resource set, RS port and/or RS port group. The term “RS” as used in one or more examples herein may refer to one or more of the following: SSB, CSI-RS, SRS, and/or DM-RS. The term “time instance” as used in one or more examples herein may refer to slot, symbol, and/or subframe.

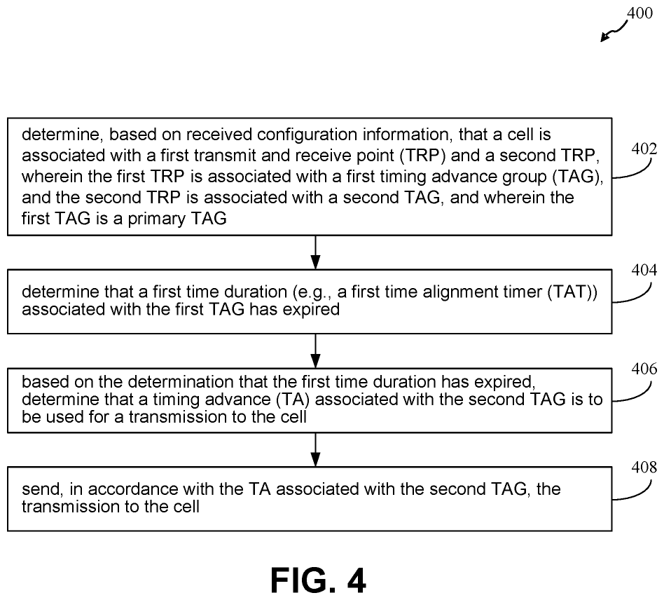

A TA process may be implemented for UL Tx modes, e.g., including MTRP/MPUE (e.g., a WTRU/UE with multiple panels). There may be one or more UL Tx modes for an MTRP/MPUE. A WTRU may be configured (e.g., from a gNB) with one or more UL transmission modes (e.g., schemes, cases, behaviors, methods, processes, procedures). A UL Tx mode (e.g., of the one or more UL Tx modes) may be based on, for example, at least one of the following: Case A (sPanel, sTRP); Case B (sPanel, selective-TRP); Case C (selective-Panel, sTRP); Case D (selective-Panel, selective-TRP); Case E (STxMP, sTRP); Case F (STxMP, selective-TRP); Case G (STxMP, multi-TRP); and/or Case X. Case A (e.g., sPanel, sTRP) may be indicated by a UL Tx based on a single WTRU panel (e.g., a group of antennas, a Tx entity controlling a Tx beam/power/timing, etc.) and/or toward (e.g., to, associated with, targeted to, linked to) a TRP/cell. Case A may be associated with a TA process, e.g., based on a TAG. Case B (e.g., sPanel, selective-TRP) may be indicated by a UL Tx based on a single WTRU panel toward a selected/indicated TRP/cell among more than one TRP/cell. Case B may be associated with one or more TA processes based on one or more TAGS (e.g., two TA processes based on two PTAGs). A WTRU may determine a TA process of the one or more TA processes, for example, based on the selected/indicated TRP/cell (e.g., as shown at 408 in FIG. 4). Case C (e.g., selective-Panel, sTRP) may be indicated by a UL Tx based on a WTRU panel selected/indicated among more than one WTRU panel, toward a TRP/cell. Case C may be associated with one or more TA processes based on one or more TAGS (e.g., two TA processes based on two PTAGs). A WTRU may determine a TA process of the one or more TA processes, for example, based on the selected/indicated WTRU panel. Case D (e.g., selective-Panel, selective-TRP) may be indicated by a UL Tx based on a WTRU panel selected/indicated among more than one WTRU panel, toward a selected/indicated TRP/cell among more than one TRP/cell. Case D may be associated with one or more TA processes based on one or more TAGS (e.g., two TA processes based on two PTAGs). A WTRU may determine a TA process of the one or more TA processes, for example, based on the selected/indicated WTRU panel and/or the selected/indicated TRP/cell. Case E (e.g., STxMP, sTRP) may be indicated by a UL Tx based on (e.g., simultaneously) more than one WTRU panel (e.g., STxMP) toward a (single) TRP/cell. Case E may be associated with one or more TA processes based on one or more TAGS (e.g., two TA processes based on two PTAGs). A WTRU may determine a first TA process (e.g., of the one or more TA processes) corresponding to a first WTRU panel of multiple WTRU-panels. A WTRU may determine a second TA process (e.g., of the one or more TA processes) corresponding to a second WTRU panel of multiple WTRU-panels. The second TA process may be associated with the first TA process (e.g., based on an offset parameter). Case F (e.g., STxMP, selective-TRP) may be UL Tx based on (e.g., simultaneously) more than one WTRU panel (e.g., STxMP) toward a selected/indicated TRP/cell among more than one TRP/cell. Case F may be associated with one or more TA processes based on one or more TAGs (e.g., two TA processes based on two PTAGs). A WTRU may determine a first TA process of the one or more TA processes, for example, based on the selected/indicated TRP/cell. The first TA process may correspond to a first WTRU panel of multiple WTRU-panels. A WTRU may determine a second TA process (e.g., of the one or more TA processes) corresponding to a second WTRU panel of the multiple WTRU-panels. The second TA process may be associated with the first TA process (e.g., based on an offset parameter). Case G (e.g., STxMP, multi-TRP) may be indicated by a UL Tx based on (e.g., simultaneously) more than one WTRU panel (e.g., STxMP) toward more than one TRP/cell, for example, based on one or more associations/linkages between a WTRU panel (e.g., of the more than one WTRU panels) and a TRP/cell (e.g., of the more than one TRP/cell). Case G may be associated with one or more TA processes based on one or more TAGs (e.g., two TA processes based on two PTAGs). A WTRU may determine a first TA process of the one or more TA processes. The first TA process may be determined based on a first combination between a first TRP/cell and a first WTRU panel of multiple WTRU-panels. A WTRU may determine a second TA process of the one or more TA processes. The second TA process may be determined, for example, based on a second combination between a second TRP/cell and a second WTRU panel of multiple WTRU-panels. Case X may be indicated by a UL Tx based on a pre-defined/pre-configured type of WTRU Tx behavior, which may be based on one or more Tx-related parameters, e.g., including target TRP(s)/cell(s). A WTRU may determine a TRP/cell (e.g., explicitly), for example, based on an indication/configuration from a gNB and/or (e.g., implicitly), for example, based on a DCI field/value or a higher-layer parameter/value being received. A TRP/cell may be associated, for example, based on at least one of a CORESET-pool-index, a TRP/cell identifier, and/or a parameter for representing the TRP/cell). In some examples, a UL Tx may be at least one of a PUSCH, PUCCH, SRS, PRACH, DMRS, and/or a (pre) defined/(pre) configured type of UL signal. One or more examples/embodiments described herein may be applicable to at least one case (e.g., Tx mode, schemes, behavior, method, process, procedure) indicated as Case A, Case B, Case C, Case D, Case E, Case F, Case G, and Case X. For example, a second TA process of one or more TA processes may be determined as shown at 406 of FIG. 4 in at least one of cases indicated as Case A, Case B, Case C, Case D, Case E, Case F, Case G, and Case X.

There may be a TAG association between a TRP/cell and a WTRU-panel (e.g., UE-panel). A WTRU may report its capability for dynamically switching between single panel UL and an MTRP/multi-panel mode (e.g., STxMP). A WTRU may receive a grant. The grant may indicate (e.g., dynamically indicate) the WTRU to schedule between sTRP/mTRP, and/or between single panel/STxMP. A grant/indication may apply to PUSCH/PUCCH or a transmission associated with a PUCSH/PUCCH. In some examples of mTRP, a grant may indicate one or more (e.g., two) sets of SRIs/transmit precoding matrix indicators (TPMIs), and power control parameters where a (e.g., each) set is associated with a TRP. In some example, a grant may include an SRS resource set indicator, which may include one or more (e.g., two) bits that (e.g., dynamically) indicate to the WTRU the scheduling between single panel on resource set 1, resource set 2, or mTRP with multiple (e.g., both) resource sets. A bit indication (e.g., an additional bit indication) may switch between the foregoing behavior and STxMP. The WTRU may adjust its precoder/spatial filter/transmit power per TRP.

A link (e.g., each link) between a WTRU panel and a TRP may have a different propagation time. The TRPs may or may not be time aligned. A single TAG may not be sufficient to achieve proper time alignment when multiple (e.g., two) panels are used in STxMP.

Timing control may be provided for an MTRP/multi-panel mode (e.g., STxMP). In some examples, a WTRU may be scheduled/configured to transmit an MTRP/multi-panel based UL (e.g., STxMP UL) of PUSCH or PUCCH on a subset of component carriers (CCs), and single panel on a second subset of CCs. A first component carrier (CC1) may be associated with multiple (e.g., two) configured TAGs. One or more other CCs may (e.g., each) be configured with a single TAG. A WTRU may (e.g., determine to) use multiple (e.g., two) TAGs, for example, if/when CC1 with an MTRP/multi-panel mode (e.g., STxMP mode) of operation is activated. A (e.g., each) TAG may be configured with its respective time duration/period (e.g., a timer such as timeAlignmentTimer). Although one or more examples herein may be described using a time alignment timer, it will be appreciated that the example(s) contemplate a time duration/period that is used in association with time alignment and/or time advance. A WTRU may determine the transmission time on a (e.g., each) panel for PUSCH or PUCCH, for example, based on the TAG associated with a (e.g., each) physical channel.

For example, a WTRU may be scheduled to transmit with a subset of layers on a first panel, and a second subset of layers on a second panel. A WTRU may determine the time instance, T1, for transmission on the first panel, for example, using a first TAG as a reference. A WTRU may (e.g., simultaneously) determine the time instance, T2, for transmission on the second panel, for example, using a second TAG as a reference.

For example, a WTRU may (e.g., similarly) determine the time instance, T1, for a PUCCH on a first panel using a first TAG as a reference, and may determine the time instance, T2, for a PUCCH on a second panel using a second TAG as a reference.

Table 1 illustrates an example of a configuration of CCs and TAGs. A WTRU may receive a configuration where CC1 may be used for an MTRP/multi-panel mode (e.g., STxMP mode of operation), and CC2/CC3 may be used for single panel mode of operation. A WTRU may (e.g., determine to) use TAG1 and TAG2 for calculating the transmission time of the respective UL panel transmissions, for example, if a WTRU is scheduled in CC1. TAG1 and/or TAG 2 may be PTAG(s).

TABLE 1
Example of TAG assignment to CCs for STxMP

| Component carrier | TAG Identity |
|---|---|
| CC1 | {TAG1, TAG2} |
| CC2 | TAG1 |
| CC3 | TAG2 |

A WTRU may receive a (e.g., single) MAC-CE to update multiple (e.g., both) timing advance values. In some examples, a timing advance command MAC-CE may include an octet (e.g., a single octet) including the TAG identity, and/or a timing advance command for the indicated TAG. In some examples, a timing advance command MAC-CE may be used for an MTRP/multi-panel mode (e.g., STxMP) that includes an (e.g., one) octet per configured TAG identity for the MTRP/multi-panel mode (e.g., STxMP), and/or a timing advance command per octet. A WTRU may receive the MAC-CE. The WTRU may (e.g., simultaneously) adjust the timing advance value for the multiple panels, for example, based on the indicated TAGs.

A TAG association may be provided for an MTRP/multi-panel based PUSCH (e.g., STxMP PUSCH). A WTRU may determine a number of TAGs to use. The WTRU may obtain information (e.g., obtain additional information) regarding the TAG per panel use. For example, the WTRU may determine such information after determining the number of TAGs to use. In some examples, a WTRU may determine an association between a TAG (e.g., TAG #X) and a panel based on an association between RS groups (e.g., SRS resource sets, CSI-RS resource sets, SSBs) and TAGs.

A WTRU may determine that TRPs (e.g., all TRPs) configured with TAG #X may include a group (e.g., one group) that may share the same timing. A WTRU may receive a configuration of SRS resource sets. An X^{th} TAG may be associated with a Y^{th} SRS resource set. In some examples multiple resource sets (e.g., two resource sets) may be utilized. For example, SRS resource set 1 may include SRS resources that a WTRU may transmit from panel 1, and SRS resource set 2 may include SRS resources that the WTRU may transmit from panel 2. SRS resource set 1 associated with TAG #1, and SRS resource set 2 may be associated with TAG #2. A configuration may include an association with a physical cell ID (PCI) number (e.g., Z) and/or an indication where a (e.g., each) PCI may represent a TRP. For example (e.g., in an inter-cell case), a CC (e.g., one CC) may be configured with multiple PCIs, and/or the TAG may be based on the target PCI for a PUCCH transmission and/or a PUSCH transmission. An association between X, Y, and Z may be configured with an RS group. For example, an SRS resource set configuration may include the X, Z values configured per SRS resource. A WTRU may receive a grant to schedule an STxMP PUSCH. A grant may include, for example, the scheduled CCs, a mode of operation, multiple (e.g., two) SRIs to determine the spatial filter per panel, and multiple (e.g., two) TPMIs to determine the precoding layer/port association per panel. A WTRU may (e.g., based on the configuration of TAGs to SRIs) determine that the first SRI from the grant is in SRS resource set Y for cell Z. The WTRU may apply TAG X. A WTRU may (e.g., similarly) determine the TAG for the second SRI in the grant. The WTRU may transmit the PUSCH with an STxMP mode of operation. The WTRU may apply the TA with the respective TAG per panel.

In some examples, a (e.g., similar) TAG association may be used for mTRP PUSCH, which is not in an STxMP mode of operation. For example (e.g., with mTRP PUSCH repetitions), a WTRU may transmit repetitions of PUSCH in a TDM mode of operation (e.g., the PUSCH repetitions may not overlap in time). The WTRU may determine the timing of a (e.g., each) PUSCH repetition, for example, based on a grant that indicates the SRI per PUSCH and/or the mTRP mode of operation. A WTRU may (e.g., based on the TAG association to SRI) determine the TAG per PUSCH transmission, e.g., similarly to the STxMP case. The determined TAG for a PUSCH transmission may be a PTAG associated with a TAT that has not expired.

TRP selection for WTRU-panel (e.g., UE-panel) association may be dynamic. A multi panel WTRU may be configured with an anchor TRP (e.g., where the RRC signaling entity is based and a secondary TRP), for example, in the context of inter-cell or intra-cell MTRP. In some examples, an anchor/primary TRP (pTRP) may be fixed. An additional TRP or secondary TRP may be changed (e.g., eventually), for example, triggered by radio resource management (RRM) measurements, reception going beyond supported MRTD or MTTD or radio link monitoring (RLM)/radio link failure (RLF) issues.

A WTRU may (e.g., initially, before being configured for MTRP operation) be configured (e.g., by a network) with RRM measurements targeting MTRP operation. In an example, specific intra-cell TRPs (e.g., CSI-RS based RSRP measurements) or inter-cell specific PCIs may serve as candidates for MTRP operations.

A TAG group candidate may be a group of beams that belong to a cell (e.g., PCI) or a collocated or quasi-collocated TRP (e.g., PCI or associated beams).

The same TAG based measurement configuration and activation may be applied, e.g., for MTRP. An RRM measurement configuration targeting MTRP may be grouped (e.g., by a gNB) into groups of collocated or quasi-collocated TRPs. The collocated or quasi-collocated TRPs groups may be part of the same TAG. A WTRU may support multiple TAGs (e.g., two TAGs such as two PTAGs) for simultaneous operation. In some examples, there may be (e.g., additional) measurement gaps for groups of TRPs (e.g., TRPs with a third TAG). In examples, TAG1 and TAG2 related measurements may not utilize gaps, while a third TAG3 group of TRPs may utilize gaps. For example, a WTRU may support “n” measurement groups without gaps. An “n+1” measurement group may utilize network configured gaps.

A WTRU supporting multiple TAGs (e.g., two TAGs) while operating in MTRP mode may have multiple sets (e.g., two sets) of resources. A secondary TRP may be switched out or in configuration (e.g., more dynamically) to maintain coverage and quality of service, for example, while a pTRP maintains its configuration.

Secondary TRP configured candidates may have the same TAG2. A WTRU may measure (e.g., continuously measure and evaluate quality of such secondary TRP configured candidates and report it to the network. The WTRU may report the quality periodically or based on an event, for example, if/when a secondary TRP candidate becomes better than a current configured TRP by a margin (e.g., RSRP) for a (e.g., selected/threshold) amount of time. A WTRU may (e.g., alternatively) trigger a report, for example, if/when the WTRU supported maximum received timing difference (MRTD) or maximum transmitted timing difference (MTTD) is exceeded while the network received a periodic TRP candidates' measurements from a WTRU. A TRP candidates' measurements may be included (e.g., piggy-backed) within the triggered report. The network may activate an RRC pre-configured candidate within a TAG2 group, for example, via MAC-CE or DCI orders. An association of resource sets with a newly activated candidate may be resolved, for example, by RRC pre-configured sets per candidate or by inheriting the old aTRP resources set, e.g., to reduce the overhead configurations.

A different TAG based measurement configuration and activation may be applied, for example, if/when a TAG3 for a secondary TRP candidates group is configured. A network may configure measurement gaps, for example, if/when a TAG3 for a secondary TRP candidates group is configured. A WTRU may report RRM based measurements for TAG3 group candidates. The report may include assistance information, e.g., in terms of receive time difference. Conditions for TAG2 replacement may be fulfilled, for example, based on an event (e.g., event-based fulfillment), RLM/RLF, and/or a quality of service below a threshold.

A network may send a MAC CE order for a TAG3 based secondary TRP activation. The MAC CE order may include (e.g., along with the activation order), for example, a PRACH order and/or an SRS transmission order for the new secondary TRP. A coarse TA command may (e.g., alternatively) be included for the newly activated secondary TRP that may be applied, for example, at the first valid UL grant for a secondary TRP.

A network may use a DCI command for activation of a new secondary TRP. A WTRU (e.g., in this case) may switch to single DCI (sDCI) mode and/or perform a PRACH and/or an SRS transmission for the associated SRS resource set with the new secondary TRP. The network may resume multi-DCI (mDCI) operation, for example, after establishing UL synchronization with the new secondary TRP.

Multi-TAG hopping operation may be performed. A WTRU may be configured with multiple TAGs (e.g., two PTAGs). A WTRU may use sDCI reception and transmissions while cycling through the activated TAGs. In some examples, the number of activated TAGs may be more than two while the maximum simultaneous TAG supported operation may be two. A WTRU may (e.g., alternatively) be configured with more than one active TRP within a TAG. A WTRU may operate using mDCI within the same TAG combined with sDCI, for example, if/when a different TAG TRP is configured. A network may configure a TAG hopping pattern for transmissions and reception at the slot of frame level.

A TRP activation delay may be implemented. A TRP activation delay with an MTRP context may depend on the type of TRP candidate. For example, an activation delay within the same TAG group may be defined by the time the WTRU acknowledges the activation order (Ack) and then the network may start scheduling the WTRU. An activation completion may (e.g., alternatively) be considered completed, for example, (e.g., only) after a valid CSI report for the newly activated TRP.

An activation delay, e.g., if/when a different TAG TRP is activated may include a UL synchronization process completion. Reception of a TA command in a RAR message may be considered as activation completion, or the Ack of the MAC CE command, for example, if a PRACH is utilized. An activation delay may include the first valid UL grant fulfilled by a WTRU (e.g., correct reception by network), for example, if the PRACH is replaced by an SRS transmission.

Dynamic TRP selection may be implemented. In some examples, a WTRU configured for an inter-cell MTRP operation may be configured with an additional PCI. A WTRU may receive more than one TAG configuration. A (e.g., each) TAG may be associated with at least one PCI. For example, a WTRU may receive two (2) TAG information (e.g., information associated with two PTAGs) corresponding to the serving and additional cells. TAG1 may be associated with the first-PCI and TAG2 may be associated with the second-PCI, or, for example, TAG1 may be associated with the first-PCI, TAG2 may be associated with the second-PCI, an dTAG3 may be associated with the 3^{rd} and 4^{th} PCIs.

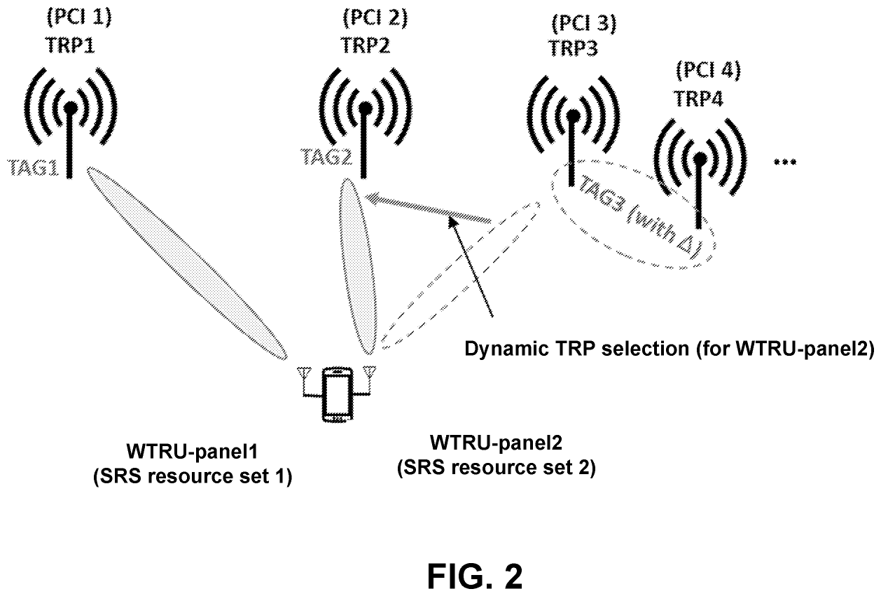

FIG. 2 illustrates an example of MTRP operation and switching with multiple TAG associations. As shown in FIG. 2, a WTRU may receive three (3) TAG configurations. The third TAG configuration may be associated with multiple (e.g., two) different PCIs, e.g., two different secondary or additional cells. In some examples (e.g., where a TAG is associated with two different PCIs), a WTRU may (e.g., also) be indicated semi-statically and/or through L1/L2 signaling of a delta value representing a potential time offset. A WTRU may (e.g., accordingly) apply an additional correction, for example, if/when applying the TAG information to timing of the transmissions to at least one of the cells associated with the TAG.

A WTRU may receive a configuration (e.g., for inter-cell MTRP) indicating that a TAG is associated with a PCI (e.g., each TAG is associated with a respective PCI for STxMP). A first-PCI may (e.g., always) be a serving-cell PCI, which may work as an anchor TRP, for example, such that it is not affected by the dynamic TRP selection for MTRP scheme (e.g., STxMP) but may be fixed as being mapped to an SRS resource set 1, e.g., unless RRC-reconfiguration. A WTRU may receive a (semi-) dynamic indication (e.g., via a MAC-CE) for selecting a PCI, for example, where the selected PCI may have a pre-association with an SRS resource set (e.g., for STxMP). An associated SRS resource set 2 (with TAG2) may be used (e.g., in addition to fixed SRS resource set 1 (with TAG1)) for an MTRP scheme (e.g., STxMP PUSCH), for example, if a second-PCI is selected/indicated via the MAC-CE (e.g., assuming a previously 3^{rd}-PCI was selected and has been used).

An SRS resource set (e.g., each SRS resource set) may be associated with a different spatial information or antenna group, for example, for a single panel WTRU. An (e.g., each) SRS resource may be associated with a different antenna panel, for example, for a multi-panel WTRU. A WTRU, e.g., configured for an inter-cell MTRP operation, may be configured with more than one SRS resource sets. An SRS resource set (e.g., each SRS resource set) may be associated with a PCI. A WTRU may determine a TAG associated with its SRS and/or other uplink transmission from the PCI associated with an SRS resource set.

In some examples, a WTRU may be configured with more than one additional PCIs, e.g., additional cells. A WTRU may be configured (e.g., further configured) with a CSI-RS for CSI measurement and report. A WTRU may use the SSB of the configured additional cell as the QCL source. A new PCI may be signaled from a list of semi-statically configured PCIs. The new PCI may be indicated as the source of TCI for downlink and/or uplink transmission, e.g., PDSCH, PDCCH, SRS, PUSCH, etc. A WTRU may be indicated a new PCI by an L1/L2 signaling. In some examples, the indication of a new PCI may be used to indicate (e.g., implicitly indicate) application of a different TAG information for an uplink transmission.

In some examples, a WTRU configured for an intra-cell MTRP operation, may receive more than one TAG configuration. A (e.g., each) TAG may be associated with at least one TCI. The TAG information may be used for determination of an uplink transmission configuration. An uplink transmission configuration may be interpreted as a different spatial information, a different antenna group, and/or a different panel. In some examples, a WTRU may receive multiple sets of TAG information corresponding to a first and a second spatial information. For example, TAG1 may be associated with the first spatial information of a same panel, and TAG2 may be associated with the second spatial information of a same panel, or, for example, TAG1 may be associated with the first WTRU panel and TAG2 may be associated with the second WTRU panel, or, for example, TAG1 may be associated with the first antenna group and TAG2 may be associated with the second antenna group. TAG1 and/or TAG2 may be PTAG(s).

In some examples, an uplink transmission configuration may be associated and sourced to an indicated downlink TCI information. In some examples, a new TCI may be indicated to a WTRU from the list of configured TCI information. A new TCI may be indicated as the QCL source for uplink transmissions, e.g., SRS, PUSCH, etc. A WTRU may be indicated a new TCI by a MAC-CE or a DCI. In some examples, an indication of a new TCI may be used to (e.g., implicitly) indicate application of a different TAG information for an uplink transmission.

A WTRU, configured for an intra-cell MTRP operation, may be configured with more than one SRS resource set. A (e.g., each) SRS resource set may be associated with a different TCI or CORESETPoolIndex. A WTRU may determine a TAG associated with its SRS and/or other uplink transmission, for example, from the TCI or CORESETPoolIndex associated with an SRS resource set.

A TRP-specific PDCCH-order may have an associated MTRP/MPUE behavior or MTRP/MPWTRU behavior. A WTRU may perform a TRP-specific PDCCH-ordered PRACH transmission. In some examples, a WTRU may perform a PDCCH ordered PRACH transmission toward a TRP. The TRP may be one of multiple TRPs associated with multi-TRP (mTRP) operation for a WTRU (e.g., a WTRU with multiple panels, Multi-Panel-User-Equipment (MPUE). For example, a WTRU may be configured with multiple TRPs for transmission and reception. The WTRU may (e.g., be indicated to) transmit a PRACH (e.g., PDCCH-ordered PRACH) toward a TRP (e.g., one of the TRPs) configured for mTRP operation. The WTRU may determine one or more parameters, time/frequency resource, and/or preamble based on the determined TRP. One or more of the following may apply. A TRP identity (e.g., TRP-id) may be assigned or allocated for a (e.g., each) TRP in the multiple TRPs configured or determined for mTRP operation. The lowest TRP-id may be assigned for a serving TRP. The serving TRP may be a serving cell in which a WTRU may perform initial access, RRC connection setup, receiving broadcasting information, etc. Serving TRP may be used interchangeably with master TRP, primary TRP, and anchor TRP in one or more examples herein. A TRP-id may be associated with a physical cell-ID (PCID). In some examples, TRP-id may be used interchangeably with cell-ID and/or physical cell-ID. A (e.g., single) PCID may be associated with multiple TRP-ids, or vice-versa. A PRACH preamble for PDCCH-ordered PRACH transmission may be determined, for example, based on a TRP-id to which the PRACH preamble is transmitted. A PRACH preamble may be configured per TRP-id. For example, a WTRU may determine a PRACH preamble based on a TRP-id determined for a PDCCH-ordered PRACH transmission. RACH occasions may be determined, for example, based on an SS/PBCH index associated with TRP-id. For example, an SS/PBCH index may be indicated in the DCI for a PDCCH order. The SS/PBCH index may determine associated RACH occasions for the PRACH transmission. The SS/PBCH index may be interpreted differently based on the TRP-id. In some examples, SS/PBCH index=x may determine a first set of RACH occasions if/when a first TRP-id (e.g., TRP-id=y1) is used or determined. SS/PBCH index=x may determine a second set of PRACH occasions if/when a second TRP-id (e.g., TRP-id=y2) is used or determined. In some examples, an SS/PBCH index may be associated with a TRP-id. For example, a first subset of SS/PBCH indexes may be associated with a first TRP-id and a second subset of SS/PBCH indexes may be associated with a second TRP-id, and so on. A PRACH mask index may be used to determine a subset of RACH occasions for a PRACH transmission. The subset of RACH occasions may be determined, for example, based on a TRP-id for a given PRACH Mask index.

A PDCCH order may be referred to as PDCCH-ordered PRACH transmission. A TRP-id may be determined for a PDCCH ordered PRACH transmission. One or more parameters for a PDCCH ordered PRACH transmission may be determined, for example, based on a TRP-id determined, selected, indicated, or used. The one or more parameters may include at least one of the following: a random access preamble index (ra-PreambleIndex); a UL/SUL indicator, which may indicate which uplink carrier to use for the PRACH transmission when a supplementary uplink is configured in a serving cell configuration; an SS/PBCH index, which may determine RACH occasions; a PRACH mask index, which may determine a subset of RACH occasions (e.g., determined from an SS/PBCH index), and so on.

In some examples, a TRP-id may be determined based on PDCCH related information for monitoring a DCI format for a PDCCH order. One or more of the following may apply: a CORESETPoolID; a CORESET-id; a PDCCH search space-id; and/or PDCCH candidate resources. In an example, a WTRU may receive a DCI for PDCCH order in a PDCCH search space. The PDCCH search space may be associated with a CORESET with a CORESETPoolID. The WTRU may determine the TRP-id, for example, based on the CORESETPoolID that may be associated with the search space in which the WTRU received the PDCCH order. A CORESETPoolID may be associated with a TRP-id and/or PCID. In an example, a WTRU may receive a DCI for a PDCCH order in a PDCCH search space. The PDCCH search space may be associated with a CORESET-id. The WTRU may determine a TRP-id, for example, based on the CORESET-id associated with the PDCCH search space. A CORESET-id may be associated with a TRP-id and/or PCID. In an example, a WTRU may receive a DCI for PDCCH order in a PDCCH search space, which may be associated with a PDCCH search space identity. The WTRU may determine the TRP-id or PCID, for example, based on the PDCCH search space identity. A search-space-id may be associated with a TRP-id and/or PCID. In an example, one or more PDCCH candidate resources may be used, configured, or available in a PDCCH search space. The WTRU may determine TRP-id and/or PCID, for example, based on which PDCCH candidate resource is used for the DCI triggering PDCCH order. For example, the first subset of PDCCH candidate resources may be associated with the first TRP-id and the second subset of PDCCH candidate resources may be associated with the second TRP-id.

In some examples, a TRP-id may be indicated (e.g., explicitly indicated) in a DCI triggering PDCCH order. For example, TRP-id or PCID may be indicated (e.g., explicitly indicated) in the DCI format used for triggering PDCCH order. One or more bits (e.g., reserved bits) may be used to indicate a TRP-id.

In some examples, a TRP-id may be (e.g., implicitly) indicated in a DCI using one or more (e.g., existing) fields. One or more of following may apply. A first TRP-id (e.g., serving TRP) may be used or determined, for example, if a frequency domain resource assignment field is of a first value (e.g., all ones). A second TRP-id (e.g., a secondary TRP) may be used or determined, for example, if the frequency domain resource assignment field is of a second value (e.g., all zeros). A UL/SUL indicator may be used to indicate a TRP-id. A UL or SUL may be determined, for example, based on one or more of following: a semi-static configuration (e.g., RRC or MAC-CE); and/or (pre) determined as a UL carrier. An MSB or LSB of a PRACH mask index may be used to indicate a TRP-id. A subset of a PRACH mask index may be applicable for a subset of RACH occasion determinations.

In some examples, one or more C-RNTIs may be used for the DCI triggering PDCCH order. A first C-RNTI may be associated with a first TRP-id and a second C-RNTI may be associated with a second TRP-id. In some examples (e.g., for a given C-RNTI), a mask may be used. For example, a first mask may be all zeros, a second mask may be all zeros except for the last digit, and so on. In some examples, one or more C-RNTIs may be configured (e.g., via a higher layer signaling). A (e.g., each) C-RNTI may be associated with a TRP-id.

In some examples, a slot index may be associated with a TRP-id. A first TRP-id may be used or determined, for example, if a WTRU received a PDCCH order in a slot with a first slot index. A second TRP-id may be used or determined, for example, if the WTRU received a PDCCH order in a slot with a second slot index. One or more of following may apply. For example, the first slot index and the second slot index may be determined based on one or more of the following: whether the slot index is even-numbered or odd-numbered; whether the slot index meets a condition or not (e.g., modulo x becomes 0); and/or whether the slot includes a flexible symbol or not. For example, the first slot index and the second slot index may be configured via a higher layer signaling.

WTRU behavior may be configured after PDCCH ordered PRACH transmission. A WTRU may receive an RAR associated with the PDCCH ordered PRACH transmission. The RAR may include at least one of the following information: associated PRACH preamble related information; an associated TRP-id; an associated TAG; and/or associated SRS resource set information. A WTRU may determine a TA for an uplink transmission associated with the TRP-id based on the received RAR.

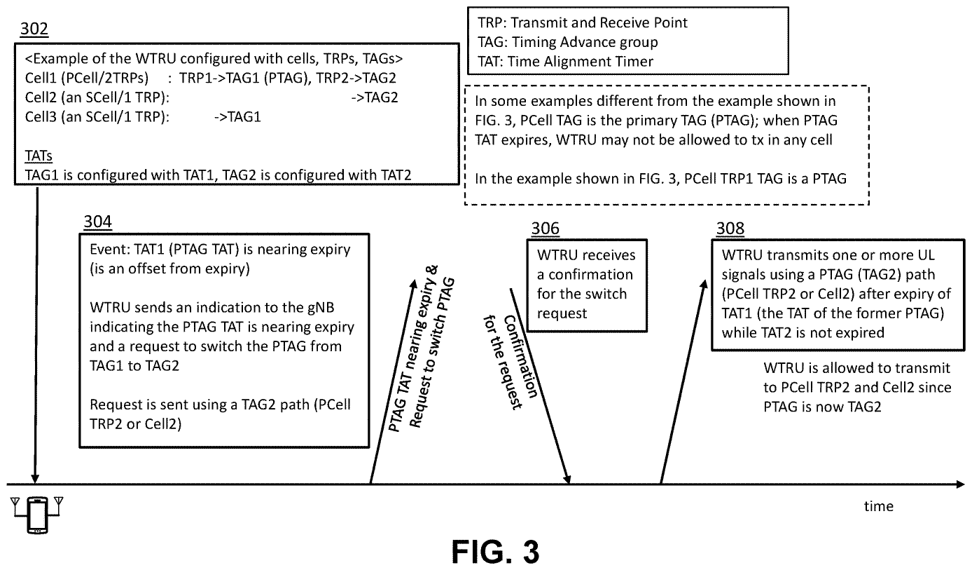

Time synchronization maintenance may be implemented per TAG. A cell (e.g., a primary cell (PCell) may be an MTRP cell. A cell (e.g., an MTRP cell) may include multiple (e.g., two or more) timing advance groups (TAG), for example, as shown at 302 of FIG. 3 or as shown at 402 of FIG. 4. A (e.g., each) TAG may be associated with one or more TRPs (e.g., the one or more TRPs associated with the TAG may be associated with the same WTRU-TRP timing alignment).

In examples, one or more TAGS (e.g., two TAGs) may be defined as the PTAG(s), for example, if the MTRP cell is a PCell.

In some examples, a PTAG may be associated with the pTRP, and one or more TAGS belonging to a PCell (e.g., additional TAGs other than the PTAG) may be described herein as the PSTAG, as indicated in Table 2 below.

TABLE 2

CC1 (SpCell) : TAG1, TAG2 → PTAG, PSTAG

A (e.g., any) TAG (e.g., other than the PTAG or PSTAG) may be described herein as STAG, for example, if the MTRP cell is a serving cell such as a secondary cell (SCell). An SCell may have at least one of: a PTAG, PSTAG, or STAG. One or more additional TAGs belonging to an SCell may be described herein as an aSTAG, indicated in Table 3 below.

TABLE 3

| | | |
|---|---|---|
| CC1 (SpCell) | : TAG1, TAG2 | → PTAG, PSTAG |
| CC2 (an SCell) | : TAG1 | → PTAG |
| CC3 (an SCell) | : TAG3, TAG4 | → STAG, aSTAG |

A DL timing reference may be determined. In an example, a WTRU may be configured with at least one MTRP mode/case (e.g., at least one among Case B, Case C, Case D, Case E, Case F, Case G, Case X) in the CC1 (e.g., SpCell), as described herein. A WTRU may (e.g., be configured/indicated to) transmit a first UL Tx part (e.g., first set of layer(s), PUCCH1, and/or from first WTRU-panel (e.g., UE-panel)), for example, based on a first DL timing reference, which may be determined based on the same cell (SpCell) associated with the PTAG.

In some examples, a WTRU may (e.g., be configured/indicated to) transmit a second UL Tx part (e.g., second set of layer(s), PUCCH2, and/or from second WTRU-panel), for example, based on a second DL timing reference, which may be determined based on one or more (e.g., any) of the activated SCells (e.g., associated with the secondary TAG (STAG) and/or aSTAG) and/or the same cell (SpCell) associated with the PSTAG and/or PTAG. A WTRU may receive a configuration/indication about how to determine a second DL timing reference.

Time synchronization may be performed or maintained using one or more time duration(s)/period(s) associated with time alignment (e.g., time alignment timers (TATs)). A WTRU (e.g., a WTRU connected to an MTRP cell) may be associated with (e.g., be configured with or configured to maintain) one or more time alignment timers (TATs). A TAT may be associated with a TAG (e.g., each TAT may be associated with a respective TAG). A TAT may start, expire, and/or reset. A TAT may be reset, for example, based on reception of a timing advance command that is addressed to a TAG associated with the TAT.

A WTRU may perform one or more of the following actions (referred to as “recovery actions” in one or more examples herein) based on an expiry of a TAT (e.g., as determined at 404 of FIG. 4): release PUCCH for one or more serving cells and/or TRPs; release SRS for one or more serving cells and/or TRPs; clear configured downlink assignments and/or configured uplink grants; clear PUSCH resource for semi-persistent CSI reporting; maintain NTA for one or more TAGS; flush HARQ buffers (e.g., all HARQ buffers) for one or more serving cells and/or TRPs; consider one or more running timers (e.g., timeAlignmentTimers) as expired.

The WTRU may release a resource associated with a physical uplink control channel (PUCCH) transmission that is scheduled to be sent to a TRP (and/or a cell), for example, based on a determination that a TAT associated with the TRP (and/or the cell) has expired. In one or more examples herein, a TAT associated with a TRP may be a TAT associated with a TAG (e.g., PTAG) associated with the TRP. The resource may have been scheduled to be used for the PUCCH transmission. The resource, when released, may not be used for the PUCCH transmission.

The WTRU may release a resource associated with a sounding reference signal (SRS) that is to be sent to a TRP (and/or a cell), for example, based on a determination that a TAT associated with the TRP (and/or the cell) has expired. The resource may have been scheduled to be used for the SRS transmission. The resource, when released, may not be used for the SRS transmission.

The WTRU may release a resource that is scheduled via a configured downlink assignment for a downlink transmission associated with a TRP (and/or a cell), for example, based on a determination that a TAT associated with the TRP (and/or the cell) has expired. The resource may have been scheduled to be used for the downlink transmission. The resource, when released, may not be used for the downlink transmission.

The WTRU may release a resource that is scheduled via a configured uplink grant for an uplink transmission associated with a TRP (and/or a cell), for example, based on a determination that a TAT associated with the TRP (and/or the cell) has expired. The resource may have been scheduled to be used for the uplink transmission. The resource, when released, may not be used for the uplink transmission.

The WTRU may release a resource that is scheduled for a physical uplink shared channel (PUSCH) transmission for channel state information (CSI) reporting (e.g., semi-persistent CSI reporting) associated with a TRP (and/or a cell), for example, based on a determination that a TAT associated with the TRP (and/or the cell) has expired. The resource may have been scheduled to be used for the PUSCH transmission for channel state information (CSI) reporting. The resource, when released, may not be used for the PUSCH transmission.

The WTRU may maintain a current NTA and may not release the NTA associated with a TRP (and/or a cell), for example, based on a determination that a TAT associated with the TRP (and/or the cell) has expired. The WTRU may determine to use the NTA being maintained as a starting reference value for determining a timing advance value, for example, when the WTRU receives a new timing advance command later.

The WTRU may or may not reset (e.g., flush) a hybrid automatic repeat request (HARQ) buffer associated with a TRP (and/or a cell), for example, based on a determination that a TAT associated with the TRP (and/or the cell) has expired. In examples, the WTRU may maintain one or more HARQ buffers (e.g., all HARQ buffers for one or more serving cells and/or TRPs). For example, the WTRU may maintain a HARQ buffer associated with the first TRP (e.g., the TRP associated with an expired TAT). The WTRU may determine that information (e.g., data or control information) transmitted via the first TRP is to be retransmitted (e.g., after the WTRU determines that the transmission of the information via the first TRP has failed). The WTRU may, based on the determination that the TAT associated with the first TRP has expired, transmit the information via the second TRP, and when the information is transmitted via the second TRP, the HARQ buffer associated with the first TRP may still include the information or a copy of the information. In examples, the WTRU may determine that information (e.g., data or control information sent from and/or received via the first TRP) is to be received via a retransmission from the second TRP (e.g., after the WTRU determines that the reception of the information via the first TRP has failed and the WTRU transmitted a NACK). The WTRU may, based on the determination that the TAT associated with the first TRP has expired, receive the information as a retransmission via the second TRP, and when the information is received as the retransmission via the second TRP, the HARQ buffer associated with the first TRP may still be used (e.g., used based on the included information or a copy of the information). In some examples, the WTRU may not maintain a HARQ buffer associated with the first TRP. For example, the WTRU may receive a transmission (e.g., a retransmission of data and/or control information that has failed to be received by the WTRU) via a TRP (e.g., the second TRP) whose associated TAT is not expired at the time of the transmission. A transmission (e.g., including data and/or control information) may be sent to a first TRP. The WTRU may attempt to decode the transmission. If the WTRU fails to decode the transmission, the WTRU may send a NACK, for example, via the first TRP. The information (e.g., the data and/or the control information) that has been sent to the WTRU may be kept in a HARQ buffer associated with the first TRP. The first TRP may be associated with a first TAT, and the second TRP may be associated with a second TAT. The WTRU may determine that the first TAT has expired. The WTRU may reset the HARQ buffer associated with the first TRP based on the determination that the first TAT has expired. The WTRU may determine that the second TAT has not expired. The WTRU may receive a retransmission of the information that the WTRU fails to decode, for example, using the second TRP and/or according to a TA associated with a TAG associated with the second TRP.

A WTRU may perform one or more (e.g., a subset) of the recovery actions described herein, for example, depending on whether the expired TAT is associated with a PTAG, PSTAG, STAG, and/or aSTAG. In examples, the WTRU may perform one or more of the recovery actions described herein if a first PTAG associated with a SpCell (e.g., a PCell, or another Special Cell) expires. The SpCell may be associated with a second PTAG. The one or more of the recovery actions described herein may be performed in association with a first TRP associated with a first TAG (e.g., the first PTAG). The one or more of the recovery actions described herein may not be performed in association with a second TRP associated with a second TAG (e.g., the second PTAG) if a TAT associated with the second TAG has not expired. In some examples, the WTRU may perform one or more of the recovery actions described herein if a STAG associated with a serving cell (e.g., a SCell) expires. The SCell may be associated with another TAG (e.g., aSTAG), a TAT of which has not expired. The one or more of the recovery actions described herein may be performed in association with a first TRP associated with the STAG. The one or more of the recovery actions described herein may not be performed in association with a second TRP associated with the other TAG(s).

A WTRU may perform one or more of the actions described herein to a different scale (e.g., resetting none, some, or all HARQ buffers). For example, a WTRU may perform one or more of the recovery actions described herein depending on the associated TAG classification (e.g., whether the expired TAT is associated with a PTAG, PSTAG, STAG, and/or aSTAG): for all TRPs in the serving cells (e.g., in all serving cells); for one or more TRPs (e.g., all TRPs other than some (e.g., the pTRP)) in the serving cells (e.g., in all serving cells); for all TRPs in serving cell(s) associated with a TAG associated with the expired TAG (e.g., in all serving cell(s) belonging to the TAG); for one or more TRPs (e.g., all TRPs other than some (e.g., the pTRP) in serving cell(s) associated with the expired TAG (e.g., in all serving cell(s)) belonging to the TAG); for all TRPs in a serving cell; and/or for one or more TRPs in a serving cell.

In examples, a WTRU may perform one or more recovery actions for some or all TRPs in the serving cells (e.g., all serving cells) if the TAT associated with the PTAG expires. For example, the WTRU may release a resource associated with a physical uplink control channel (PUCCH) transmission that is scheduled to be sent to the cell or the first TRP, release a resource associated with a sounding reference signal (SRS) that is to be sent to the cell or the first TRP, release of a resource that is scheduled via a configured downlink assignment for a downlink transmission associated with the cell or the first TRP, release a resource that is scheduled via a configured uplink grant for an uplink transmission associated with the cell or the first TRP, release a resource that is scheduled for a physical uplink shared channel (PUSCH) transmission for semi-persistent channel state information (CSI) reporting associated with the cell or the first TRP, but the WTRU may not flush a HARQ buffer associated with some or all TRPs in the serving cells (e.g., all serving cells). In some examples, if the PSTAG expires, a WTRU may perform one or more recovery actions for some or all TRPs in the serving cells (e.g., all serving cells), for example, other than the TRP(s) associated with the PTAG. In some examples, a WTRU may perform one or more recovery actions for some or all TRPs in the serving cells associated with a STAG (e.g., all serving cells belonging to the STAG) if the TAT associated with the STAG expires. In some examples, a WTRU may perform one or more recovery actions for some or all TRPs associated with an aSTAG (e.g., all TRPs that belong to the aSTAG) if the TAT associated with the aSTAG expires.

A time duration (e.g., a TAT) associated with a PTAG may expire. A WTRU may avoid additional data loss and/or service interruption, for example, if the WTRU avoids the expiry (and/or the impact(s) due to the expiry) of a TAT associated with a PTAG, which, in some examples, may cause recovery actions for one or more serving cells (e.g., all serving cells as opposed to only the serving cell(s) associated with the PTAG). Another PTAG may be configured and/or promoted.

A cell (e.g., a PCell) may be associated with more than one PTAGs, e.g., based on configuration. A WTRU may (e.g., if a PCell is an MTRP cell) promote a TAG (e.g., a PSTAG) to a second PTAG, for example, if the TAT associated with a first PTAG expires and the TAT associated with one or more TAGS (e.g., one or more PSTAGs) is still valid.

A TAG (e.g., a PSTAG) may be promoted to a PTAG (e.g., through PTAG addition or PTAG swapping). In examples, a second PTAG may be configured in addition to a first PTAG. In some examples, a WTRU may promote a PSTAG to a PTAG. A WTRU may promote a TAG (e.g., a PSTAG) to a PTAG, for example, subject to one or more of the following conditions: whether the PCell includes multiple TRPs; based on a NW configuration (e.g., an RRC configuration to enable/disable promotion to PTAG), which may be per TAG or may have a configuration for TAGs (e.g., one configuration for all TAGs); based on an NW indication (e.g., via reception of an explicit indication in system information, MAC CE, or DCI); whether the TAT associated with the PTAG has expired or is about to expire; whether the TAT associated with another TAG (e.g., the PSTAG) is still running; whether the TAT associated with another TAG (e.g., the PSTAG) has a configured amount of time remaining; or whether the RSRP on one or more TRP links is above a threshold; and/or based on at least one procedure/behavior related to L1/L2 mobility management/handling, for example, for fast handover (e.g., to switch to a new serving-cell/TRP/PCI) versus a Layer-3 (L3) based handover (e.g., one involving a longer time and/or an RRM procedure). The WTRU may send an UL transmission to a cell (e.g., a PCell) using a TA associated with the additionally configured and/or promoted PTAG.

The WTRU may determine to send an UL transmission to a cell (e.g., a PCell) using a TA associated with the additionally configured and/or promoted PTAG if the cell includes multiple TRPs. In examples, a WTRU may promote (or not) a TAG (e.g., a PSTAG) to a PTAG based on a determination of whether the PCell includes multiple TRPs. For example, the WTRU may not promote a TAG to a PTAG if the PCell doe not include multiple TRPs. The WTRU may promote a TAG to a PTAG if the PCell includes multiple TRPs and/or other condition(s) is satisfied.

The WTRU may determine, based on a NW configuration, to send an UL transmission to a cell (e.g., a PCell) using a TA associated with the additionally configured and/or promoted PTAG. The cell may be configured with a first PTAG and a second PTAG, and a NW configuration indicative of such may be sent, which may be a configuration per TAG or may have a configuration for one or more TAGS (e.g., one configuration for all TAGS). For example, the NW configuration may include an RRC configuration (e.g., an RRC configuration to enable/disable promotion to PTAG). The WTRU may receive the NW configuration and/or determine, based on the NW configuration, that the cell is configured with a first PTAG and a second PTAG. The WTRU may receive the NW configuration and/or determine, based on the NW configuration, that the second PTAG is to be promoted. In examples, a WTRU may promote a TAG (e.g., a PSTAG) to a PTAG based on the NW configuration, which may be a configuration per TAG or may have a configuration for one or more TAGS (e.g., one configuration for all TAGs).

The WTRU may determine, based on a NW indication, to send an UL transmission to a cell (e.g., a PCell) using a TA associated with the additionally configured and/or promoted PTAG. A cell (e.g., a PCell) may be configured with a first PTAG and a second PTAG, and an NW indication indicative of such may be sent. A WTRU may receive the NW indication (e.g., via reception of an explicit indication in system information, MAC CE, or DCI). The WTRU may determine, based on an NW indication, that the cell is configured with a first PTAG and a second PTAG. The WTRU may receive the NW indication and/or determine, based on the NW indication, that the second PTAG is to be promoted. In examples, a WTRU may promote a TAG (e.g., a PSTAG) to a PTAG based on the NW indication (e.g., via reception of an explicit indication in system information, MAC CE, or DCI).

The WTRU may determine to send an UL transmission to a cell (e.g., a PCell) using a TA associated with the additionally configured and/or promoted PTAG if the TAT associated with the first PTAG has expired. The WTRU may send an UL transmission to a cell (e.g., a PCell) using a TA associated with the additionally configured and/or promoted PTAG if the TAT associated with the first PTAG is near expiry. In examples, a WTRU may promote (or not) a TAG (e.g., a PSTAG) to a PTAG based on a determination of whether the TAT associated with the PTAG has expired (or a determination of whether the TAT is about to expire). For example, the WTRU may promote a TAG (e.g., a PSTAG) to a PTAG based on a determination that the TAT associated with the PTAG has expired or is about to expire, and the WTRU may not promote the TAG to a PTAG based on a determination that the TAT associated with the PTAG has not expired and is not about to expire.

The WTRU may determine to send an UL transmission to a cell (e.g., a PCell) using a TA associated with the additionally configured and/or promoted PTAG if the TAT associated with the first PTAG has expired and the TAT associated with the additionally configured and/or promoted PTAG (e.g., the PSTAG) is still running. In examples, a WTRU may promote (or not) a TAG (e.g., a PSTAG) to a PTAG based on a determination of whether the TAT associated with the TAG is still running. For example, the WTRU may promote a TAG (e.g., a PSTAG) to a PTAG based on a determination that the TAT associated with the PTAG has expired or is about to expire and a determination that the TAT associated with the TAG (e.g., the PSTAG) is still running. The WTRU may not promote the TAG to a PTAG based on a determination that the TAT associated with the TAG has expired or is near expiry.

The WTRU may determine to send an UL transmission to a cell (e.g., a PCell) using a TA associated with the additionally configured and/or promoted PTAG if the TAT associated with the first PTAG has expired and the TAT associated with the additionally configured and/or promoted PTAG (e.g., the PSTAG) has a configured amount of time remaining. In examples, a WTRU may promote (or not) a TAG (e.g., a PSTAG) to a PTAG based on a determination of whether the TAT associated with the TAG (e.g., the PSTAG) has a configured amount of time remaining. For example, the WTRU may promote a TAG (e.g., a PSTAG) to a PTAG based on a determination that the TAT associated with the PTAG has expired or is about to expire and a determination that the TAT associated with the TAG has a configured amount of time remaining. The WTRU may not promote the TAG to a PTAG based on a determination that the TAT associated with the TAG does not have a configured amount of time remaining.

The WTRU may determine to send an UL transmission to a cell (e.g., a PCell) using a TA associated with the additionally configured and/or promoted PTAG if the RSRP on one or more TRP links associated with the additionally configured and/or promoted PTAG is above a threshold. In examples, a WTRU may promote (or not) a TAG (e.g., a PSTAG) to a PTAG based on a determination of whether the RSRP on one or more TRP links associated with the TAG is above a threshold. For example, the WTRU may promote a TAG (e.g., a PSTAG) to a PTAG based on a determination that the TAT associated with the PTAG has expired or is about to expire and a determination that the RSRP on one or more TRP links associated with the TAG is above a threshold. The WTRU may not promote the TAG to a PTAG based on a determination that the RSRP on one or more TRP links associated with the TAG is not above the threshold.

The WTRU may send an UL transmission to a cell (e.g., a PCell) using a TA associated with the additionally configured and/or promoted PTAG if the additional PTAG, for example, as shown at 308 of FIG. 3, is configured and/or made available through a promotion. In examples, a WTRU may promote a TAG (e.g., a PSTAG) to a PTAG, for example, if one or more of the conditions described herein are satisfied. A WTRU may send an UL transmission according to a TA associated with the TAG (e.g., the WTRU may promote the TAG to PTAG to send the UL transmission), for example, when one or more of the following occur: when the TAT associated with the PTAG expires; when an offset time from the expiry of the TAT associated with the PTAG has been reached; when an NW indication/command is received; and/or when an offset time from the time of the reception of the NW indication/command has been reached.

In examples, a WTRU may send an UL transmission according to a TA associated with a second PTAG if the TAT associated with a first PTAG expires. The WTRU may determine that the TAT associated with the first TAG has expired, and, based on the determination that the first TAT has expired, the WTRU may determine that a TA associated with the second TAG is to be used for a transmission to a cell. The WTRU may send, in accordance with the TA associated with the second TAG, the transmission to the cell. In some examples, the WTRU may determine data or control information that is to be sent to the cell. The WTRU may determine that the TAT associated with the second TAG has not expired. The WTRU may, based on the determination that the TAT associated with the first TAG has expired and the determination that the TAT associated with the second TAG has not expired, send, in accordance with the TA associated with the second TAG, the data or control information to the cell. The WTRU may, based on the determination that the TAT associated with the first TAG has expired and the determination that the TAT associated with the second TAG has not expired, refrain from sending, using a TA associated with the first TAG, the data or control information. For example, the WTRU may, based on the determination that the TAT associated with the first TAG has expired and the determination that the TAT associated with the second TAG has not expired, refrain from sending, using a TA associated with the first TAG, an (e.g., any) UL transmission except the Random Access Preamble and MSGA transmission.

A WTRU may activate a stored configuration (e.g., perform an RRC reconfiguration and/or activate a conditional handover (CHO) configuration) to determine that a second TAG is to be used for a transmission (e.g., to promote the PSTAG associated with a TRP to the PTAG). Activation of the configuration may be based on, for example, the expiry of the TAT associated with a first TAG and/or reception of an NW indication/confirmation. In examples, the first TAG and/or the second TAG may be PTAG(s). In some examples, a WTRU may, for example, delay performing one or more recovery actions while awaiting confirmation from the NW regarding PSTAG promotion.

The expiry of a TAT (e.g., a PTAG TAT) and/or the near expiry (e.g., imminent expiry) of the TAT may be indicated, for example, as shown at 304 of FIG. 3. In examples, a WTRU may indicate to the network that the TAT associated with a TAG (e.g., the TAT associated with a first PTAG) has expired. In some examples, a WTRU may indicate that the TAT associated with the TAG (e.g., the TAT associated with the first PTAG) is about to expire (e.g., the WTRU may send the indication at a fixed offset time from or before the expiry of the TAT). A WTRU may send an indication, for example, to one or more of: a TRP associated with a PTAG (e.g., a first PTAG or a second PTAG); a TRP associated with a PSTAG; a TRP link associated with the highest RSRP; a (e.g., any) TRP link associated with an RSRP that is above a threshold; a (e.g., any) TRP link associated with a valid TAT (e.g., the TAT is still running); or a (e.g., any) TRP link associated with a TAT having a certain amount of remaining time until the expiry of the TAG (e.g., the fixed amount of time left until TAT expiry).

The expiry of a TAT (e.g., a PTAG TAT) and/or the near expiry of the TAT may be indicated using various approaches. In examples, a WTRU may send an indication, for example, via one or more of the following approaches: MAC CE; RRC (e.g., WTRU information response message(s)); during RACH (e.g., Msg3, Msg5, MsgA); UCI; PUSCH resource; or PUCCH resource.

An indication of the expiry of a TAT (e.g., a PTAG TAT) and/or the near expiry of the TAT may include or be sent along with other information. In examples, a WTRU may include within the indication or may send along with the indication, for example, one or more of the following pieces of information: an indication that a TAT is near expiry (e.g., a flag indicating that the TAT associated with a PTAG is about to expire); a request to promote one or more TAGS (e.g., one or more PSTAGs) to PTAG(s); a remaining time until the TAT (e.g., the TAT associated with PTAG(s) expires; a TRP to promote (e.g., a preferred TRP to promote) and/or a TAG to promote (e.g., a PSTAG to promote to a PTAG); a remaining time until the expiry of certain TAT(s) (e.g., until TAT expiry for some or all PSTAGs); or RSRP(s) of one or more TRP links.

Which information to include in the indication (or be sent along with the indication) may be based on one or more of the following (e.g., the information a WTRU may include within the indication may depend on one or more of the following): the signalling method to send the information (e.g., RRC vs. MAC CE vs. RACH signaling); the NW configuration and/or request; whether the TAG (e.g., the PTAG) has expired or is about to expire; whether a valid alternative link is available (e.g., whether a valid alternative link is available for promotion); how many valid alternative link(s) are available; or whether a stored configuration (e.g., the stored configuration in one or more examples herein) is available (e.g., whether a stored configuration is available to promote the PSTAG to PTAG).

A WTRU may send an indication, for example, based on a configuration. The configuration may indicate, for example, one or more of the following: an offset from expiry to transmit the indication; a signaling method; and/or the type of information to send within the indication.

A WTRU may receive confirmation of the request to use the second TAG for an UL transmission, for example, as shown at 306 of FIG. 3. Confirmation of the request may be indicated by a network. A network may send the confirmation (e.g., a confirmation response) based on (e.g., upon) reception of the indication in one or more examples herein (e.g., a PTAG expiry indication) and/or the request in one or more examples herein (e.g., a PSTAG promotion request). In some examples, the network may indicate the confirmation of PTAG swapping (e.g., a virtual PTAG swapping). The confirmation (e.g., a confirmation response) may include, for example, one or more of the following pieces of information: HARQ ACK feedback to the request (e.g., the PTAG swap request); an explicit confirmation (e.g., a flag) indicating that the request is accepted; a configuration indicating that the second TAG is to be used for an UL transmission (e.g., a configuration to promote the PSTAG to the PTAG); an activation time to use the second TAG for the UL transmission (e.g., an activation time to promote the PSTAG to the PTAG); or an indication of which TAG is to be used for the UL transmission (e.g., an indication which PSTAG among multiple candidates to promote).

A WTRU may receive the confirmation (e.g., a NW confirmation), for example, via one or more of the following methods: MAC CE; RRC; during a RACH (e.g., Msg2, Msg4, MsgB); DCI; PDSCH resource; and/or PDCCH resource.

A WTRU may receive an approval of the request to use the second TAG for the UL transmission (e.g., an NW response that the PTAG swap request is accepted). In examples, the WTRU may, based on the approval of the request, send the UL transmission using a TA associated with the second TAG, for example, in accordance with (e.g., any) conditions within the NW confirmation. In some examples, the WTRU may (e.g., based on the reception of the NW response) promote the PSTAG to the PTAG, for example, in accordance with (e.g., any) conditions within the NW confirmation (e.g., the WTRU may apply an activation time indicated in the NW confirmation (message) and/or apply a configuration indication within the NW confirmation).

A NW may reject the request (e.g., the request for PTAG promotion). A WTRU may assume that the request (e.g., the request to promote a PSTAG to PTAG) is denied, for example, if the WTRU does not receive a response from the NW. A WTRU may assume that the request is denied, for example, if the WTRU does not receive a response after one or more of the following: a time duration/period (e.g., the PTAG timer such as the TAT associated with the PTAG) expires prior to receiving an NW response (e.g., the confirmation); the WTRU doesn't receive an NW response within X time and/or Y recourse units; and/or a candidate TAG to use for the UL transmission (e.g., a candidate TAG for promotion) becomes invalid prior to an NW response.

A WTRU may perform actions associated with the expiry of a TAG (e.g., PTAG expiry) if the request (e.g., the PSTAG promotion request) is denied and/or the WTRU doesn't receive a response to the request in time.

A WTRU may indicate that the WTRU is to send or has sent the UL transmission using the second PTAG. In some examples, the WTRU may confirm PTAG promotion. The WTRU may indicate successful promotion of a TAG (e.g., a PSTAG) to a PTAG to the network if the TAG is successfully promoted to a PTAG. For example, a WTRU may perform a RACH on the TRP associated with the second PTAG (e.g., the PTAG that has been promoted). In some examples, a WTRU may send the indication (e.g., explicitly such as via a confirmation MAC CE).

One or more examples herein may be applicable to SCells. In examples (e.g., as described herein), PTAG may be substituted for STAG, and PSTAG may be substituted with aSTAG. In examples, a TAG associated with SCells may be promoted. One or more examples (e.g., as described herein) may (e.g., additionally and/or alternatively) apply to promotion of an aSTAG to an STAG for TRPs belonging to an SCell.

FIG. 3 illustrates an example of a PTAG switching or maintaining a PTAG on a different TRP.

In examples (e.g., as in the example illustrated based on FIG. 3), at 302, a WTRU may receive configuration information indicating a first cell is associated with a first and second TRP (e.g., where the first and second TRP are each associated with a respective first and second timing advance group (TAG), the first and second TAG are each associated with a respective first and second time alignment timer (TAT), and the first TAG is a primary TAG). At 304, the WTRU may determine that the first TAT is near expiry (e.g., the current time may be an offset time before an expiry of the first TAT (e.g., the offset time has been reached), or a remaining time until (e.g., before) the expiry of the first TAT may be less than a threshold, where the threshold may be configured or indicated (e.g., from a gNB) to the WTRU). In examples, the WTRU may report its capability information related to the threshold. In one or more examples herein, the term “expiry” and “expiration” may be interchangeably used.

At 304, the WTRU may transmit, for example, based on the determination, to the second TRP associated with the second TAG or to a second cell associated with the second TAG, a message indicating that the first TAT is near expiry (e.g., the current time may be an offset time before an expiry of the first TAT (e.g., the offset time has been reached), or a remaining time until (e.g., before) the expiry of the first TAT may be less than a threshold, where the threshold may be configured or indicated (e.g., from a gNB) to the WTRU) and/or may transmit a request to switch the primary TAG from the first TAG to the second TAG. At 306, the WTRU may receive confirmation (e.g., approval) for the request to switch. At 308, the WTRU may transmit one or more UL signals to the first cell or the second cell (e.g., using a TA associated with the second TAG) after the expiry of the first TAT (e.g., while the second TAT is not expired). For example, the WTRU may be allowed to transmit to the first cell (and the second cell) when the TAT associated with the primary TAG is not expired. The WTRU may maintain the ability to transmit a UL signal or channel by switching a primary TAG to a different TAG (e.g., a different PTAG) before a TAT associated with the primary TAG fails and/or expires (e.g., the WTRU may improve its performance by being able to transmit after the expiry of the timer for the initial primary TAG). In examples (e.g., alternatively), the PTAG switching (e.g., swapping) behavior(s) may be applicable based on a 1-PTAG model or a 2-PTAG model.

For a 1-PTAG model, a TAG may be PTAG (e.g., only one TAG of SpCell is PTAG, and the other TAG of the SpCell is STAG). An SpCell, for example, may include PCell, or other Special Cell (e.g., in a different cell group such as in a dual-connectivity scenario, etc.) In examples, a TAG associated with a certain TAG ID (e.g., the lowest indexed TAG ID in the SpCell) may be the PTAG.

For 2-PTAG model, more than one TAGs may be PTAGs (e.g., both TAGs of SpCell are PTAGs). An SpCell, for example, may include PCell, or other Special Cell (e.g., in a different cell group such as in a dual-connectivity scenario, etc.)

In examples, the 2-PTAG model may be applied. For example, the example of FIG. 3 may be applicable for the 2-PTAG model. In FIG. 3, the WTRU may be associated with one or more cells (e.g., an SpCel and SCells). The WTRU may avoid performing expiry actions on the one or more cells if a TRP of a cell of the one or more cells has a valid TAT (e.g., as long as one TRP of the first cell (e.g., SpCell, PCell) still has a valid TAT, then the WTRU may continue operation (e.g., communications, DL receptions and/or UL transmissions) on the first cell and may avoid performing expiry actions on all cells (e.g., including SCells)). In examples, the WTRU may receive configuration information indicating a first cell is associated with a first and second TRP (e.g., where the first and second TRP are each associated with a respective first and second TAG, the first and second TAG are each associated with a respective first and second TAT, and both the first TAG and the second TAG may be primary TAG, as show at 402 of FIG. 4). The WTRU may determine that the first TAT is near expiry (e.g., the current time may be an offset time before an expiry of the first TAT (e.g., the offset time has been reached), or a remaining time until (e.g., before) the expiry of the first TAT may be less than a threshold, where the threshold may be configured or indicated (e.g., from a gNB) to the WTRU). In examples, the WTRU may report its capability information related to the threshold.

The WTRU may transmit, for example, based on the determination, to the second TRP associated with the second TAG or to a second cell associated with the second TAG, a message indicating the first TAT is near expiry and/or may indicate that the second TAG is to be used (e.g., the WTRU may transmit an indication, information, or a request, indicating that the second TAG instead of the first TAG is to be used (e.g., applied) in determining whether to perform the ‘recovery actions’ across cells). The WTRU may perform a virtual PTAG switching or swapping (e.g., a “virtual” PTAG switching or swapping (from the first TAG to the second TAG) although both first and second TAGs are PTAG in the 2-PTAG model), for example, when the 2-PTAG model herein is used. The WTRU may receive confirmation (e.g., approval) for the indication (or information/request). The WTRU may transmit one or more UL signals to the first cell or the second cell (e.g., using a TA associated with the second TAG, for example, as shown at 408 of FIG. 4) after the expiry of the first TAT (e.g., while the second TAT is not expired).

FIG. 4 illustrates an example 400 of TAG switching for a transmission. At 402, a WTRU may determine, based on received configuration information, that a cell is associated with a first TRP and a second TRP. The first TRP may be associated with a first TAG. The second TRP may be associated with a second TAG. The first TAG may be a primary TAG. At 404, the WTRU may determine that a first time duration (e.g., a first TAT) associated with the first TAG has expired. At 406, based on the determination that the first time duration has expired, the WTRU may determine that a TA associated with the second TAG is to be used for a transmission to the cell. At 408, the WTRU may send, based on the TA associated with the second TAG, the transmission to the cell.

A TAT expiry may be associated with PSTAG or aSTAG. A TAT may expire for a TRP that is not the primary TRP for a cell. A WTRU may suspend or delay recovery actions or perform recovery actions (e.g., only) on a limited subset of (e.g., one or more) TRPs, for example, if the TAT associated with the TAG of the TRP expires.

A WTRU may notify the network (e.g., similar to examples described for PSTAG promotion), for example, if/when the TAT associated with a non-primary TAG (e.g., PSTAG or aSTAG) has expired or is about to expire. The network may respond, for example, by indicating one or more of the following actions to perform: trigger cell search to find another candidate cell/PCI from another candidate PCI list; revert to sTRP; and/or perform one or more recovery actions (e.g., as described herein).

A WTRU may perform one or more actions (e.g., as described herein), for example, based on a configuration, and/or conditionally, such as based on whether the expired TAT is associated with the PSTAG or the aSTAG.

One or more examples described herein may be applicable for (or applied in conjunction with or based on) other scenarios, such as L1/L2 mobility management/handling, which may provide a fast handover (e.g., to switch to a new serving-cell/TRP/PCI), versus Layer-3 (L3) based handover, which may involve a longer time and/or RRM procedure.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU) comprising:
a processor configured to:
determine, based on configuration information, that a cell is associated with a first transmit and receive point (TRP) and a second TRP, wherein the first TRP is associated with a first timing advance group (TAG), and the second TRP is associated with a second TAG, and wherein the first TAG is a primary TAG;
determine that a first time alignment timer (TAT) associated with the first TAG has expired;
based on the determination that the first TAT has expired, send an indication that the second TAG is to be used as the primary TAG;
determine a timing advance (TA) associated with the second TAG; and
send, based on the TA associated with the second TAG, a transmission to the cell.

17. The WTRU of claim 16, wherein the cell is associated with two primary TAGs, the first TAG is a first primary TAG associated with the cell, and the second TAG associated with the second TRP is a second primary TAG associated with the cell.

18. The WTRU of claim 16, wherein the second TAG is associated with a second TAT, and the processor is further configured to:
determine data or control information that is to be sent to the cell;
determine that the second TAT has not expired; and
based on the determination that the first TAT has expired and the determination that the second TAT has not expired, send, based on the TA associated with the second TAG, the data or control information to the cell.

19. The WTRU of claim 18, wherein the processor is further configured to, based on the determination that the first TAT has expired and the determination that the second TAT has not expired, refrain from sending, based on a TA associated with the first TAG, the data or control information.

20. The WTRU of claim 16, wherein the processor is further configured to:
determine that data or control information transmitted via the first TRP is to be retransmitted; and
based on the determination that the first TAT has expired, transmit the data or control information via the second TRP, wherein, when the data or control information is transmitted via the second TRP, a hybrid automatic repeat request (HARQ) buffer associated with the first TRP comprises the data or control information.

21. The WTRU of claim 16, wherein the processor is further configured to, based on the determination that the first TAT has expired, perform one or more of: a release of a resource associated with a physical uplink control channel (PUCCH) transmission that is scheduled to be sent to the cell or the first TRP; a release of a resource associated with a sounding reference signal (SRS) that is to be sent to the cell or the first TRP; a release of a resource that is scheduled via a configured downlink assignment for a downlink transmission associated with the cell or the first TRP; a release of a resource that is scheduled via a configured uplink grant for an uplink transmission associated with the cell or the first TRP; or a release of a resource that is scheduled for a physical uplink shared channel (PUSCH) transmission for semi-persistent channel state information (CSI) reporting associated with the cell or the first TRP.

22. The WTRU of claim 16, wherein the processor is further configured to:
determine that an offset time has been reached, wherein the offset time is before the expiration of the first TAT; and
send a request, based on the determination that the offset time has been reached, to indicate that the second TAG is to be used as the primary TAG, wherein the request is sent before the expiration of the first TAT.

23. The WTRU of claim 22, wherein the processor is further configured to send a first transmission based on the TA associated with the second TAG, wherein the first transmission comprises the request, and wherein the first transmission further comprises an indication that the offset time has been reached.

24. The WTRU of claim 16, wherein the processor is further configured to:
determine that the first TAT expires at a first time; and
determine that a difference between a current time and the first time is less than or equal to a value; and
send a request, based on the determination that the difference between the current time and the first time is less than or equal to the value, to change the primary TAG from the first TAG associated with the first TRP to the second TAG associated with the second TRP, and wherein the request is sent before the expiration of the first TAT.

25. A method performed by a wireless transmit/receive unit (WTRU), comprising:
determining, based on configuration information, that a cell is associated with a first transmit and receive point (TRP) and a second TRP, wherein the first TRP is associated with a first timing advance group (TAG), and the second TRP is associated with a second TAG, and wherein the first TAG is a primary TAG;
determining that a first time alignment timer (TAT) associated with the first TAG has expired;
based on the determination that the first TAT has expired, sending an indication that the second TAG is to be used as the primary TAG;
determining a timing advance (TA) associated with the second TAG; and
sending, based on the TA associated with the second TAG, a transmission to the cell.

26. The method of claim 25, wherein the cell is associated with two primary TAGs, the first TAG is a first primary TAG associated with the cell, and the second TAG associated with the second TRP is a second primary TAG associated with the cell.

27. The method of claim 25, wherein the second TAG is associated with a second TAT, and the method further comprises:
determining data or control information that is to be sent to the cell;
determining that the second TAT has not expired; and
based on the determination that the first TAT has expired and the determination that the second TAT has not expired, sending, based on the TA associated with the second TAG, the data or control information to the cell.

28. The method of claim 27, further comprising, based on the determination that the first TAT has expired and the determination that the second TAT has not expired, refraining from sending, based on a TA associated with the first TAG, the data or control information.

29. The method of claim 25, further comprising:
determining that data or control information transmitted via the first TRP is to be retransmitted; and
based on the determination that the first TAT has expired, transmitting the data or control information via the second TRP, wherein, when the data or control information is transmitted via the second TRP, a hybrid automatic repeat request (HARQ) buffer associated with the first TRP comprises the data or control information.

30. The method of claim 25, further comprising, based on the determination that the first TAT has expired, performing one or more of: a release of a resource associated with a physical uplink control channel (PUCCH) transmission that is scheduled to be sent to the cell or the first TRP; a release of a resource associated with a sounding reference signal (SRS) that is to be sent to the cell or the first TRP; a release of a resource that is scheduled via a configured downlink assignment for a downlink transmission associated with the cell or the first TRP; a release of a resource that is scheduled via a configured uplink grant for an uplink transmission associated with the cell or the first TRP; or a release of a resource that is scheduled for a physical uplink shared channel (PUSCH) transmission for semi-persistent channel state information (CSI) reporting associated with the cell or the first TRP.

31. The method of claim 25, further comprising:
determining that an offset time has been reached, wherein the offset time is before the expiration of the first TAT; and
sending a request, based on the determination that the offset time has been reached, to indicate that the second TAG is to be used as the primary TAG, wherein the request is sent before the expiration of the first TAT.

32. The method of claim 31, further comprising sending a first transmission based on the TA associated with the second TAG, wherein the first transmission comprises the request, and wherein the first transmission further comprises an indication that the offset time has been reached.

33. The method of claim 25, further comprising:
determining that the first TAT expires at a first time; and
determining that a difference between a current time and the first time is less than or equal to a value; and
sending a request, based on the determination that the difference between the current time and the first time is less than or equal to the value, to change the primary TAG from the first TAG associated with the first TRP to the second TAG associated with the second TRP, and wherein the request is sent before the expiration of the first TAT.
